(19) United States
(12) Patent Application Publication
(10) Pub. No.: US 2024/0204540 A1
(43) Pub. Date: Jun. 20, 2024

(54) ACTIVE CELL BALANCING

(71) Applicant: TEXAS INSTRUMENTS INCORPORATED, Dallas, TX (US)

(72) Inventors: Branko MAJMUNOVIC, Dallas, TX (US); Johan STRYDOM, Saratoga, CA (US)

(21) Appl. No.: 18/340,399

(22) Filed: Jun. 23, 2023

Related U.S. Application Data
(60) Provisional application No. 63/387,295, filed on Dec. 14, 2022.
(60) Provisional application No. 63/479,218, filed on Jan. 10, 2023.

(51) Int. Cl. H02J 7/00; H01M 10/42; H01M 10/44

(52) U.S. Cl. CPC H02J 7/0019; H01M 10/425; H01M 10/441; H01M 2010/4271

(57) ABSTRACT

A system includes a first battery, a second battery, an integrated circuit, a capacitor, and an inductor. The first battery has first and second battery terminals. The second battery has a third and fourth battery terminals. The second battery terminal is coupled to the third battery terminal. The integrated circuit includes a first transistor, a second transistor, a third transistor, and a fourth transistor. The first transistor is coupled between the first battery terminal and a capacitor terminal. The second transistor is coupled between the capacitor terminal and the second battery terminal. The third transistor is coupled between the third battery terminal and an inductor terminal. The fourth transistor is coupled between the inductor terminal and the fourth battery terminal. The capacitor and the inductor are coupled in series. The capacitor is coupled to the capacitor terminal and the inductor coupled to the inductor terminal.

### CROSS-REFERENCE TO RELATED APPLICATIONS

This application claims priority to U.S. Provisional Application No. 63/387,295, filed Dec. 14, 2022, entitled “Active Cell Balancing with Phase-Shifted Stacked Active Bridges,” and to U.S. Provisional Application No. 63/479,218, filed Jan. 10, 2023, entitled “Active Cell Balancing with Phase-Shifted Stacked Active Bridges,” both of which are hereby incorporated by reference.

### BACKGROUND

High voltage energy storage systems may include a number of energy storage cells, such as batteries, connected in series. The capacity of the stacked cells may differ due to internal (e.g., internal impedance) or external (e.g., temperature) factors. This variation in capacity may result in differences in charging and discharging of cells, which may cause charge imbalances across the stack, and limit the energy capacity of the system.

### SUMMARY

In one example, an integrated circuit (IC) includes a first transistor, a second transistor, a third transistor, a fourth transistor, and a control circuit. The first transistor is coupled between a first battery terminal and a capacitor terminal. The first transistor has a first transistor control terminal. The second transistor is coupled between the capacitor terminal and a second battery terminal. The second transistor has a second transistor control terminal. The third transistor is coupled between a third battery terminal and an inductor terminal. The third transistor has a third transistor control terminal. The third battery terminal is coupled to the second battery terminal. The fourth transistor is coupled between the inductor terminal and a fourth battery terminal. The fourth transistor has a fourth transistor control terminal. The control circuit has a control input and first, second, third, and fourth control outputs. The first control output is coupled to the first transistor control terminal, the second control output is coupled to the second transistor control terminal, the third control output is coupled to the third transistor control terminal, and the fourth control output is coupled to the fourth transistor control terminal.

In another example, a method includes connecting a capacitor and an inductor between a first battery terminal and a second battery terminal of a first battery cell to store a first voltage across the capacitor. A capacitor terminal of the capacitor is connected to the first battery terminal, and an inductor terminal of the inductor is connected to the second battery terminal. The method also includes disconnecting the inductor terminal from the second battery terminal, connecting the inductor terminal to the first battery terminal to store the first voltage across the inductor, and disconnecting the capacitor terminal from the first battery terminal. The method further includes connecting the capacitor terminal to a third battery terminal of a second battery cell to transfer charge from the first battery cell to the second battery cell at a rate based on the first voltage and an inductance of the inductor.

In a further example, a system includes a first battery, a second battery, an integrated circuit, a capacitor, and an inductor. The first battery has a first battery terminal and a second battery terminal. The second battery has a third battery terminal and a fourth battery terminal. The second battery terminal is coupled to the third battery terminal. The integrated circuit includes a first transistor, a second transistor, a third transistor, and a fourth transistor. The first transistor is coupled between the first battery terminal and a capacitor terminal. The second transistor is coupled between the capacitor terminal and the second battery terminal. The third transistor is coupled between the third battery terminal and an inductor terminal. The fourth transistor is coupled between the inductor terminal and the fourth battery terminal. The capacitor and the inductor are coupled in series. The capacitor is coupled to the capacitor terminal and the inductor is coupled to the inductor terminal.

In a yet further example, a battery assembly includes a first battery module, a second battery module, a first transistor, a second transistor, a third transistor, a fourth transistor, and a control circuit. The first battery module includes a first module terminal, a second module terminal, a first battery, and a second battery. The first battery and the second battery are coupled in series between the first module terminal and the second module terminal. The second battery module includes a third module terminal, a fourth module terminal, a third battery, and a fourth battery. The third battery and the fourth battery are coupled in series between the third module terminal and the fourth module terminal. The third module terminal is coupled to the second module terminal. The first transistor is coupled between the first module terminal and a first resonant component terminal. The first transistor has a first transistor control terminal. The second transistor is coupled between the first resonant component terminal and the second module terminal. The second transistor has a second transistor control terminal. The third transistor is coupled between the third module terminal and a second resonant component terminal. The third transistor has a third transistor control terminal. The fourth transistor is coupled between the second resonant component terminal and the fourth module terminal. The fourth transistor has a fourth transistor control terminal. The control circuit has a control input and first, second, third, and fourth control outputs. The first control output is coupled to the first transistor control terminal. The second control output is coupled to the second transistor control terminal. The third control output is coupled to the third transistor control terminal. The fourth control output is coupled to the fourth transistor control terminal.

### BRIEF DESCRIPTION OF THE DRAWINGS

FIGS. 1A and 1B show examples of charge redistribution in a battery module that includes active cell balancing.

FIG. 2 is a block diagram of an example battery module that includes active cell balancing.

FIG. 3 is a schematic diagram of an example of the active cell balancing circuit of FIG. 2.

FIG. 4 is a graph of example signals in the active cell balancing circuit of FIG. 3 illustrating transfer of charge between battery cells.

FIGS. 5 and 6 are schematic diagrams of example active cell balancing circuits with input filtering.

FIG. 7 is a block diagram illustrating an example of charge transfer from one battery cell to two battery cells in the battery module of FIG. 2.

FIG. 8 is a block diagram illustrating an example of multiple simultaneous charge transfers between battery cells of the battery module of FIG. 2.

FIGS. 9A and 9B illustrate an example of charge transfer across six battery cells in the battery module of FIG. 2.

FIGS. 10A and 10B illustrate an example of charge transfer across three battery cells in the battery module of FIG. 2.

FIGS. 11A and 11B illustrate an example of simultaneous charge transfer across three battery cells and two battery cells in the battery module of FIG. 2.

FIGS. 12A and 12B illustrate another example of simultaneous charge transfer across three battery cells and two battery cells in the battery module of FIG. 2.

FIG. 13 is a block diagram of an example of a portion of an active cell balancing circuit that includes multiple active cell balancing integrated circuits coupled in series.

FIG. 14 is a schematic diagram of an active cell balancing circuit that includes a disconnect switch between LC circuits.

FIG. 15 is a schematic diagram of an active cell balancing circuit configured for two-phase operation.

FIG. 16 is a flow diagram for an example method of active cell balancing.

FIG. 17 is a schematic diagram of another example active cell balancing circuit.

FIGS. 18A and 18B illustrate an example of simultaneous charge transfer between battery cells using an example of the active cell balancing circuit of FIG. 17.

FIG. 19 is a schematic diagram of an example of the active cell balancing circuit of FIG. 17 that includes a disconnect switch.

FIG. 20 is a block diagram of an example of the active cell balancing circuit of FIG. 17 that includes a network of parallel capacitors.

FIG. 21 is a schematic diagram of an active cell balancing circuit configured for two-phase operation based on the active cell balancing circuit of FIG. 17.

FIG. 22 is a schematic diagram of another example active cell balancing circuit.

FIG. 23 is a schematic diagram of an example of the active cell balancing circuit of FIG. 22 that includes a disconnect switch.

FIG. 24 is a schematic diagram of an active cell balancing circuit configured for two-phase operation based on the active cell balancing circuit of FIG. 22.

FIG. 25 is a schematic diagram of another example active cell balancing circuit.

FIG. 26 is a schematic diagram of an example of the active cell balancing circuit of FIG. 25 that includes a disconnect switch.

FIG. 27 is a schematic diagram of an active cell balancing circuit configured for two-phase operation based on the active cell balancing circuit of FIG. 25.

FIG. 28 is a block diagram of a battery assembly that includes balancing across battery modules.

### DETAILED DESCRIPTION

High-voltage battery modules include multiple low-voltage battery cells coupled in series. The series connection of the low-voltage battery cells limits the capacity of the battery module to the capacity of the weakest low-voltage battery cell. For example, as the battery-pack is being discharged, the weakest cell discharges at the highest rate, and has the smallest state-of-charge (SOC). As the SOC of this cell reaches its lowest allowed value (e.g., the lowest value allowed by a battery manager coupled to the cell), the battery module can be disconnected, and charged stored in other battery cells of the pack is not used. Similarly, as the battery module is being charged, the charging can be halted when the battery cell with the smallest capacity is fully charged, leaving the stronger cells partially charged.

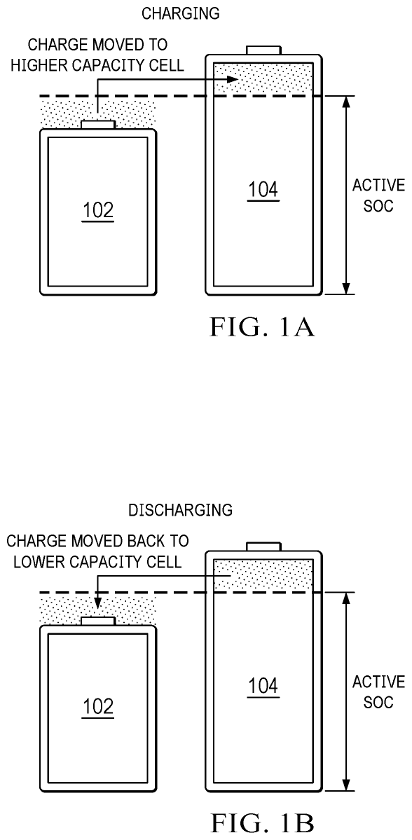

Active cell balancing is one technique for managing the SOC of the battery cells in a battery module. Active cell balancing redistributes charge across the cells of a battery module to reduce the differences in charge between the battery cells. For example, an active balancing circuit can transfer charge from a battery cell with a higher SOC to a battery cell with a lower SOC. FIGS. 1A and 1B show examples of charge redistribution in a battery module that includes active cell balancing. In FIG. 1A, the battery cells 102 and 104 are being charged. The battery cell 102 is weaker than the battery cell 104. For example, the battery cell 102 charges and discharges more quickly than the battery cell 104. Active balancing circuitry moves charge from the battery cell 102 to the battery cell 104 during charging to allow both the battery cell 102 and the battery cell 104 to fully charge. Without active balancing, the 102 may be fully charged before the battery cell 104, and charging may be halted before the battery cell 104 is fully charged. Accordingly, the active balancing circuitry increases the total charge stored in the battery module.

In FIG. 1B, the battery cells 102 and 104 are being discharged. The battery cell 102 discharges more quickly than the battery cell 104. Active balancing circuitry moves charge from the battery cell 104 to the battery cell 102 during discharging to allow both the battery cell 102 and the battery cell 104 to discharge to a same degree. Without active balancing, the battery cell 102 may be discharged before the battery cell 104, and the battery module disconnected (e.g., discharging of the battery module discontinued) before the battery cell 104 is discharged. Accordingly, the active balancing circuitry increases the total charge provided by the battery module.

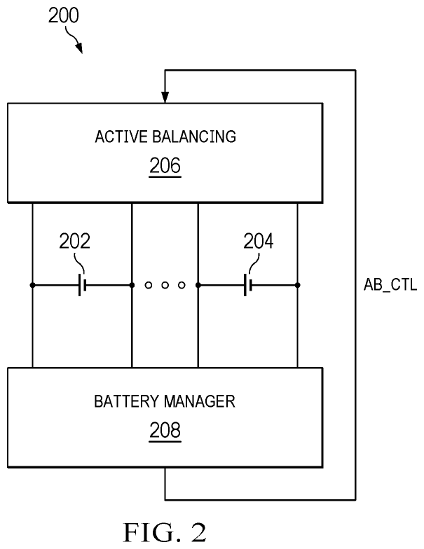

FIG. 2 is a block diagram of an example battery module 200 that can perform active cell balancing. The battery module 200 includes multiple battery cells. Battery cells 202 and 204 are shown in FIG. 2, but the battery module 200 may include more than two battery cells. The battery module 200 also includes an active cell balancing circuit 206 and a battery manager circuit 208. The active cell balancing circuit 206 and the battery manager circuit 208 are coupled to the battery cell 202 and the battery cell 204. The battery manager circuit 208 monitors the voltage of the battery cell 202 and the battery cell 204, and the current flowing from the battery cell 202 and the battery cell 204 to determine the SOC of the battery cell 202 and the battery cell 204. The battery manager circuit 208 can include measurement circuitry (e.g., an analog-to-digital converter, sampling circuitry, sensing circuitry, etc.) to measure the battery cell 202 and the battery cell 204 voltage and current. The battery manager circuit 208 can include a microcontroller or other computation circuitry configured to determine SOC based on the current and voltage measurements.

Based on the SOC of the battery cell 202 and the battery cell 204, the battery manager circuit 208 can generate an active balancing control signal (AB_CTL). AB_CTL can specify that charge be transferred from the battery cell 202 to the battery cell 204 if the SOC of battery cell 202 is greater than the SOC of the battery cell 204, or can specify that charge be transferred from the battery cell 204 to the battery cell 202 if the SOC of battery cell 204 is greater than the SOC of the battery cell 202. For example, the AB_CTL can specify a rate and a duration of charge transfer between the battery cell 202 and the battery cell 204 based on the SOC of the battery cell 202 and the battery cell 204.

The active cell balancing circuit 206 receives AB_CTL and transfers charge between the battery cell 202 and the battery cell 204 based on balancing parameters (e.g., charge transfer source, charge transfer destination, charge transfer rate, and charge transfer duration, start transfer, stop transfer, and/or other parameters) specified by AB_CTL. As noted above, the battery module 200 may include more than two battery cells, and the active cell balancing circuit 206 can transfer charge between any of the battery cells of the battery module 200.

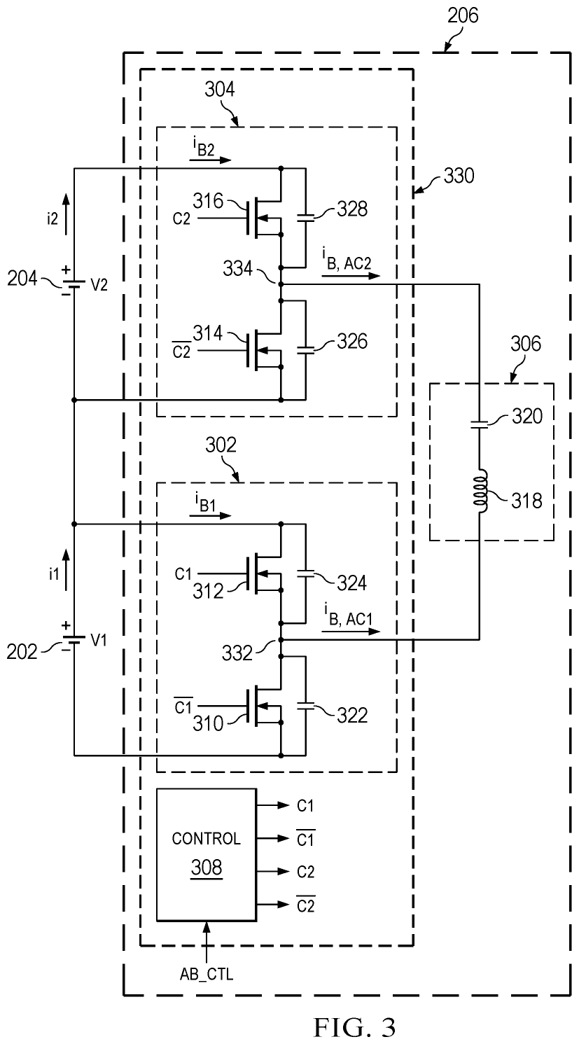

FIG. 3 is a schematic diagram of an example of the active cell balancing circuit 206 (or a portion thereof for 2 adjacent battery cells). FIG. 3 also shows the adjacent battery cell 202 and battery cell 204 coupled to the active cell balancing circuit 206. The active cell balancing circuit 206 includes a half-bridge circuit 302, a half-bridge circuit 304, an inductor-capacitor (LC) circuit 306, and a control circuit 308. The half-bridge circuit 302 is coupled in parallel with the battery cell 202, and includes a first battery terminal coupled to a first terminal of the battery cell 202, and a second battery terminal coupled to a second terminal of the battery cell 202. Similarly, the half-bridge circuit 304 is coupled in parallel with the battery cell 204, and includes a first battery terminal coupled to a first terminal of the battery cell 204, and a second battery terminal coupled to a second terminal of the battery cell 204.

Each half-bridge circuit includes a pair of transistors. The transistors can be n-channel field effect transistors (NFETs). The half-bridge circuit 302 includes transistors 310 and 312. A first terminal (e.g., source) of the transistor 310 is coupled to the second battery terminal, and a second terminal (e.g., drain) of the transistor 310 is coupled to a switch node 332. A capacitor 322 represents a drain-to-source capacitance of the transistor 310. A first terminal (e.g., source) of the transistor 312 is coupled to the switch node 332, and a second terminal (e.g., drain) of the transistor 312 is coupled to the first battery terminal. A capacitor 324 represents a drain-to-source capacitance of the transistor 312.

The half-bridge circuit 304 includes transistors 314 and 316, and a switch node 334. A first terminal (e.g., source) of the transistor 314 is coupled to a first terminal of the battery cell 204, and a second terminal (e.g., drain) of the transistor 314 is coupled to the switch node 334. A capacitor 326 represents a drain-to-source capacitance of the transistor 314. A first terminal (e.g., source) of the transistor 316 is coupled to the switch node 334, and a second terminal (e.g., drain) of the transistor 316 is coupled to a second terminal of the battery cell 204. A capacitor 328 represents a drain-to-source capacitance of the transistor 316.

The LC circuit 306 is coupled between the switch node 332 and the switch node 334. The LC circuit 306 includes an inductor 318 and a capacitor 320 coupled in series. The capacitor 320 capacitively couples the half-bridge circuit 302 and the half-bridge circuit 304. The capacitance of the capacitor 320 and the inductance of the inductor 318 can be relatively small. For example, the inductance of the inductor 318 may be 50 nanohenries and the capacitance of the capacitor 320 may be 3 microfarads in some implementations of the active cell balancing circuit 206. The voltage across the transistor 310, the transistor 312, the transistor 314, the transistor 316, the inductor 318, or the capacitor 320 can be limited to about the voltage of a single battery cell. Accordingly, the voltage rating of these components can be relatively low.

The control circuit 308 receives AB_CTL provided by the battery manager circuit 208 (FIG. 2) and generates driver signals that control the transistors 310, 312, 314, and 316. The control circuit 308 generates the driver signals C1, C̅1̅, C2, and C̅2̅, and provides the driver signals at outputs of the control circuit 308 that are coupled to control inputs (e.g., gates) of the transistors 310, 312, 314, and 316. C̅1̅ can be an inverted version of C1 with a deadtime interval between the edges of C1 and C̅1̅, and C2 and C̅2̅ can be phase-shifted versions of C1 and C̅1̅. By controlling the switching of the transistors 310, 312, 314, and 316 with select phase shift between the driver signals provided to the half-bridge circuit 302 and half-bridge circuit 304, the active cell balancing circuit 206 can transfer charge from the battery cell 202 to the battery cell 204, or from the battery cell 204 to the battery cell 202. In some examples, the driver signals C1, C̅1̅, C2, and C̅2̅ can each have a duty cycle of 50%. In some examples, the duty cycle can deviate from 50% to improve efficiency when the imbalance between the cell voltages is high. In some examples, discontinuous conduction mode (DCM) operation can also be performed in extreme cases of the voltage imbalance between the battery cells to reduce loss.

In some examples of the active cell balancing circuit 206, the control circuit 308 can be distributed across the half-bridge circuits. For example, a portion of the control circuit 308 that generates the control signals C1 and C̅1̅ can be provided in a first sub-circuit with the half-bridge circuit 302, and a portion of the control circuit 308 that generates the control signals C2 and C̅2̅ can be provided in a second sub-circuit with the half-bridge circuit 304. With the control circuit 308 distributed across the half-bridge circuits, each portion of the control circuit 308 can receive transfer parameters, such as source, sink, and current via the AB_CTL, and adjust the phase of the control signals generated to maintain the specified current.

The half-bridge circuit 302, the half-bridge circuit 304, and the control circuit 308 may be incorporated in an integrated circuit 330. Some examples of the integrated circuit 330 may also include the inductor 318. Examples of the integrated circuit 330 may include any number of half-bridge circuits (e.g., half-bridge circuit 302, half-bridge circuit 304) coupled in series, with the control circuit 308 configured to control the half-bridge circuits.

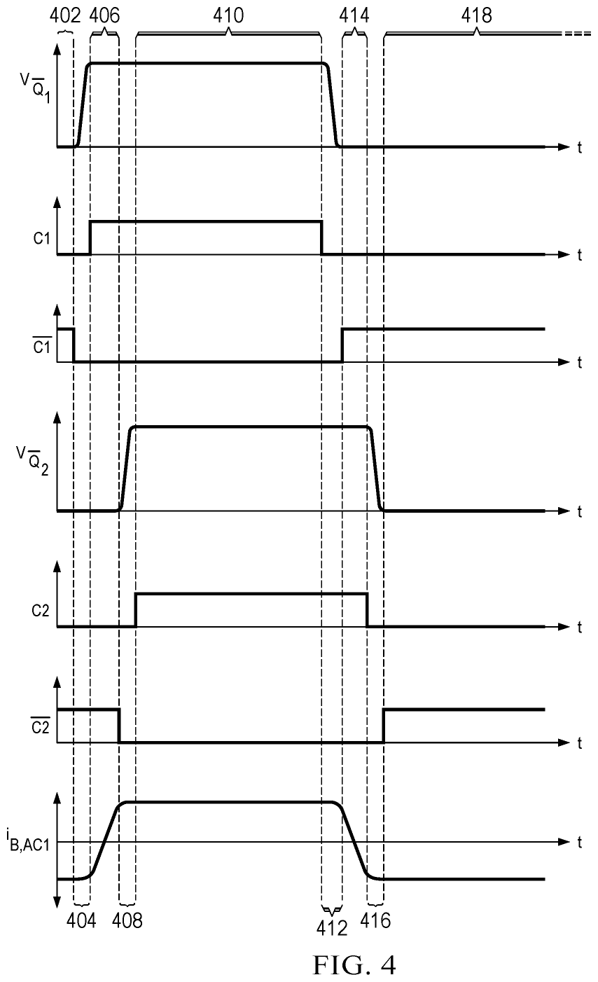

FIG. 4 is a graph of signals in the active cell balancing circuit 206 that illustrate transfer of charge from the battery cell 202 to the battery cell 204 during switching cycles of the half-bridge circuits 302 and 304. In the interval 402, the control circuit 308 provides C̅1̅ and C̅2̅ in a first state to turn on the transistors 310 and 314, and provides C1 and C2 in a second state to turn off the transistors 312 and 316. The voltage across the transistors 310 and 314 is zero or near zero. The current i_{B,AC1} is negative.

In the interval 404, the control circuit 308 provides C2 in the first state to turn on the transistor 314, and provides C̅1̅, C1 and C2 in the second state (C̅1̅ transitions from the second state to the first state) to turn off the transistors 310, 312, and 316. The transistor 312 can be turned off with zero voltage switching. The voltage (VQ̅₁) across the transistor 310 increases.

In the interval 406, after the voltage across the transistor 310 has risen to a selected value, the control circuit 308 can provide C1 in the first state to turn on the transistor 312. Current i_{B,AC1} flows through the transistor 312 due to the battery voltage across the inductor 318. In this configuration, the transistors 310 and 316 are off, and the transistor 312 and transistor 314 are on to provide a path for current flow. The capacitor 320 can provide capacitive isolation between adjacent battery cells and can have a relatively low voltage tolerance (e.g., 5 Volt), as described above. The voltage across the capacitor 320 can be an average of the voltage v1 across the battery cell 202 and the voltage v2 across the battery cell 204. The voltage across the inductor 318, which has opposite polarity from the voltage across the capacitor 320 (so that the total voltage is zero as switch nodes 334 and 332 are shorted together by transistors 314 and 312), causes the current flowing through the inductor 318 (i_{B,AC1}) to increase (ramps up), and the ramp rate can be determined by the inductance of inductor 318. The duration of interval 406 can determine the amount of increase of the current before it stops increasing, and the amount of charge transfer.

In the interval 408, after the current flowing to the inductor 318 has increased to a selected value, and the control circuit 308 can provide C̅2̅ in the second state to turn off the transistor 314. In this configuration, the transistors 310, 314, and 316 are off, and the transistor 312 is on. The voltage (VQ̅₂) across the transistor 314 increases.

In the interval 410, after the voltage across the transistor 314 has increased to a selected value, the control circuit 308 can provide C2 in the first state to turn on the transistor 316 with zero voltage switching. In this configuration, the transistors 310 and 314 are off, and the transistors 312 and 316 are on. The voltage across the inductor 318 is zero, and the current through the inductor (i_{B,AC1}) stays at (or near) the selected value. In the interval 410 (the power transfer interval), charge is transferred to the battery cell 204 from the LC circuit 306. Accordingly, charge transferred from the battery cell 202 to the LC circuit 306 is transferred to the battery cell 204.

In the interval 412, the control circuit 308 can provide C1 in the second state to turn off the transistor 312. The voltage (VQ̅₁) across the transistor 310 falls.

In the interval 414, after the voltage across the transistor 310 has fallen to a selected value, the control circuit 308 can provide C̅1̅ in the first state to turn on the transistor 310 with zero voltage switching. The current i_{B,AC1} decreases and becomes negative.

In the interval 416, when the current flowing in the inductor 318 has fallen to a selected value, the control circuit 308 can provide C2 in the second state to turn off the transistor 316. The voltage (VQ̅₂) across the transistor 314 falls.

In the interval 418, when the voltage across the transistor 314 has fallen to a selected value, the control circuit 308 can provide the C̅2̅ in the first state to turn on the transistor 314 with zero voltage switching. In the interval 418, the active cell balancing circuit 206 is in the same state as the interval 402 for execution of a successive power transfer cycle.

In FIG. 4, the inductor 318 and the capacitor 320 can form a resonant circuit and support soft switching, and the switch nodes (332 and 334) can commutate without discharging capacitors 322, 324, 326, and 328. Such arrangements can speed up the switching and allow half-bridge circuits 302 and 304 to operate at a higher switching frequency, which in turn allows the devices of half-bridge circuits 302 and 304 to be made smaller. The increased switching frequency can also reduce the time for capacitor 320 to block a DC voltage, which can also reduce the size of capacitor 320.

While FIG. 4 illustrates transfer of charge from the battery cell 202 to the battery cell 204, transfer of charge from the battery cell 204 to the battery cell 202 can be provided by swapping the timing of the signals C1 and C̅1̅ in FIG. 4 with timing of the signals C2 and C̅2̅ in FIG. 4.

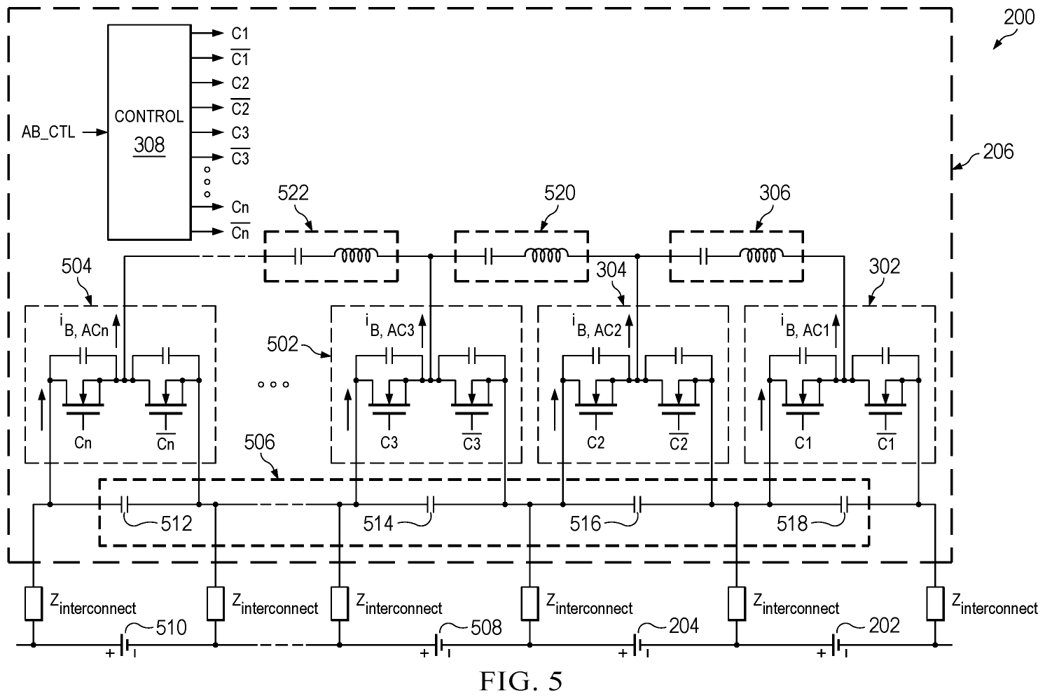

FIG. 5 is schematic level diagram of example of the active cell balancing circuit 206 that includes input filtering. In the example of FIG. 5, the active cell balancing circuit 206 includes the half-bridge circuits 302, 304, 502, and 504, and the LC circuits 306, 520, and 522. The active cell balancing circuit 206 can include any number of half-bridge circuits, where each half-bridge circuit is coupled to an adjacent half-bridge circuit by an LC circuit (e.g., an example of the LC circuit 306). All of the half-bridge circuits can be similar or identical, and all of the LC circuits can be similar or identical. The half-bridge circuits 302, 304, 502, and 504 are respectively coupled to battery cells 202, 204, 508, and 510 via conductors represented as Z_{interconnect}.

The active cell balancing circuit 206 also includes an input filter circuit 506. The input filter circuit 506 includes capacitors 512, 514, 516, and 518. The capacitor 512 is coupled between the battery terminals of the half-bridge circuit 504. The capacitor 514 is coupled between the battery terminals of the half-bridge circuit 502. The capacitor 516 is coupled between the battery terminals of the half-bridge circuit 304. The capacitor 518 is coupled between the battery terminals of the half-bridge circuit 302. Generally, the input filter circuit 506 includes a capacitor that is coupled between the battery terminals of each of the half-bridge circuits of the active cell balancing circuit 206. Each of the capacitors of the input filter circuit 506 blocks the DC voltage of a single battery cell. When transferring charge between two battery cells (e.g., from battery cell 202 to battery cell 510), the equivalent capacitance of the input filter circuit 506 is C/(j−1), where C is the capacitance of each capacitor of the input filter circuit 506 and j is the number of capacitors of the input filter circuit 506 connected in series between the two battery cells (e.g., j=3 when transferring charge from the battery cell 202 to the 508).

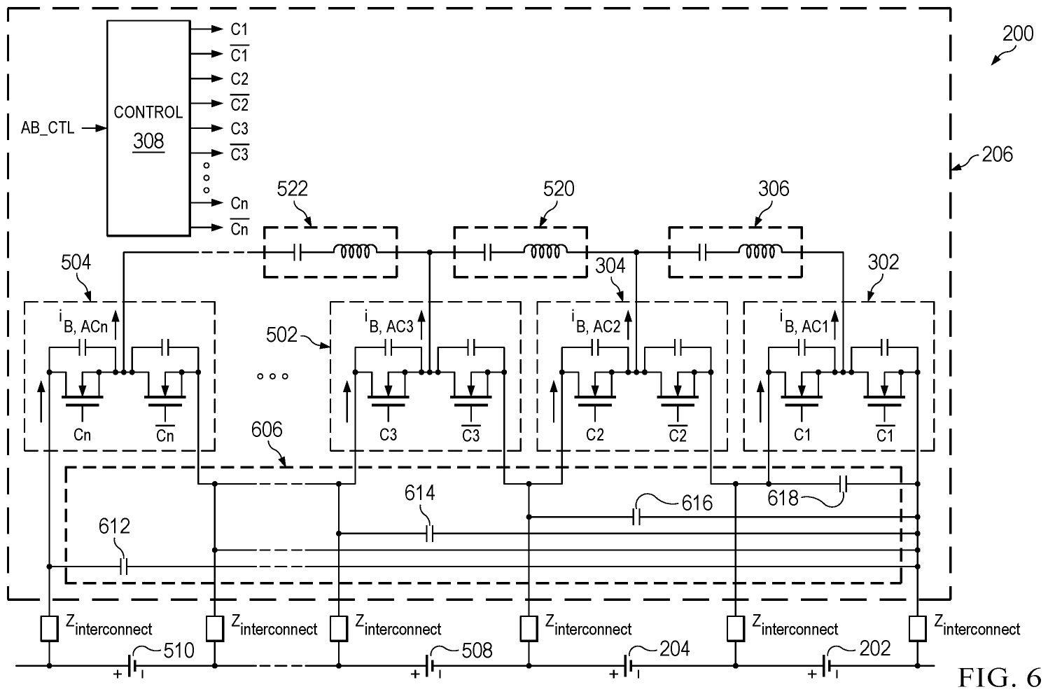

FIG. 6 is a schematic level diagram of an example of the active cell balancing circuit 206 that is similar to that of FIG. 5, but includes different input filtering. In FIG. 6, the active cell balancing circuit 206 includes an input filter circuit 606 in place of the input filter circuit 506. The input filter circuit 606 includes capacitors 612, 614, 616, and 618. The capacitor 612 is coupled across the battery cells 510, 508, 204, and 202. The capacitor 614 is coupled across the battery cells 508, 204, and 202. The capacitor 616 is coupled across the battery cells 204 and 202. The capacitor 618 is coupled across the battery cell 202. Each of the capacitors blocks the DC voltage of the series connected batteries that the capacitor is connected across. When transferring charge between two battery cells, the equivalent capacitance of the input filter circuit 606 is C (the capacitance of one capacitor of the input filter circuit 606). Accordingly, the input filter circuit 606 may reduce the AC signal path capacitance between battery cells relative to the input filter circuit 506.

In examples of the active cell balancing circuit 206, the current transferred from one battery cell to another may be modeled as:

$$I = \frac{V φ}{8 π L {f}_{s w}} ( 1 - \frac{φ}{π} ) \qquad ( 1 )$$

where:
V is battery voltage;
L is the inductance of the an inductor, such as inductor 318;
φ is the phase shift between the driver signals driving the half-bridge circuits (e.g., C1 and C1); and
fsw is switching frequency.

Accordingly, the phase shift generated by the control circuit 308 to provide a selected transfer of charge between battery cells may be determined as:

$$φ = \frac{π}{2} - \sqrt{( \frac{π}{2} ) - \frac{8 {π}^{2} L {f}_{sw} I}{V}} \qquad ( 2 )$$

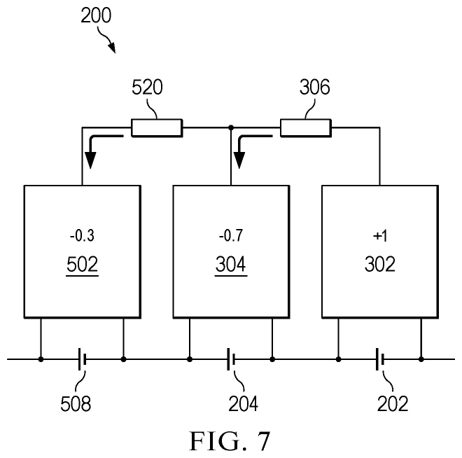

FIG. 7 is a block diagram illustrating an example of charge transfer from one battery cell to two battery cells in the battery module 200. In FIG. 7, the battery module 200 includes battery cells 202, 204, and 508 respectively coupled to half-bridge circuits 302, 304, and 502, and LC circuits 306 and 520 coupled to the half-ridge circuits. The half-bridge circuit 502 can be the same as the half-bridge circuit 302, and the LC circuit 520 can be the same as the LC circuit 306. In the example of FIG. 7, charge can be simultaneously transferred from the battery cell 202 to the battery cell 204 and the battery cell 508. The driver signals provided to the half-bridge circuits 302, 304, and 502 cause 70% of the charge provided by the battery cell 202 to be directed to the battery cell 204, and 30% of the charge provided by the battery cell 202 to be directed to the battery cell 508. The amounts of charge directed to each of the battery cell 204 and the battery cell 508 is determined by the phases of the driver signals C1, C2, and C3 provided to the half-bridge circuits 302, 304, and 502 by the control circuit 308. The control circuit 308 can determine the phase shift applied to C2 (relative to C1) as:

$${φ}_{2 - 1} = \frac{π}{2} - \sqrt{( \frac{π}{2} ) - \frac{8 {π}^{2} L {f}_{s w} {I}_{1 A}}{V}} \qquad ( 3 )$$

where I_{1A} specifies 1 ampere of total current flowing from the battery cell 202 to the battery cell 204 and the battery cell 508.

The control circuit 308 can determine the phase shift applied to C3 (relative to C2) as:

$${φ}_{3 - 2} = \frac{π}{2} - \sqrt{( \frac{π}{2} ) - \frac{8 {π}^{2} L {f}_{s w} {I}_{0.3 A}}{V}} \qquad ( 4 )$$

where I_{0.3A} specifies 0.3 amperes of current flowing from the battery cell 202 to the battery cell 508. In some examples, the control circuit 308 can be coupled to a current sensor that senses the amount of current flowing between two half-bridges. The control circuit 308 can set the phase shift of switching of the two half-bridges based on the sensed current, to provide closed loop control of the current.

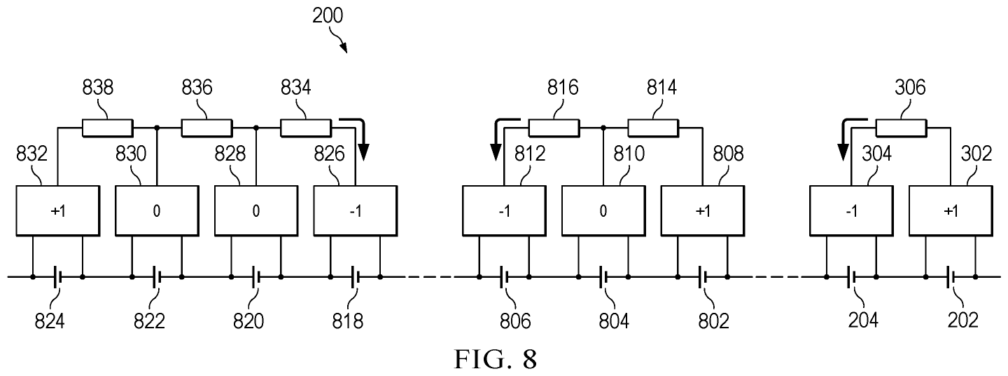

FIG. 8 is a block diagram illustrating an example of multiple charge transfers between battery cells of the battery module 200. In FIG. 8, the battery module 200 includes battery cells 202, 204, 802, 804, 806, 818, 820, 822, and 824, half-bridge circuits 302, 304, 808, 810, 812, 826, 828, 830, and 832 coupled to the battery cells, and LC circuits 306, 814, 816, 834, 836, and 838 coupled to the half-bridge circuits. The half-bridge circuits 808, 810, 812, 826, 828, 830, and 832 can be the same as the half-bridge circuit 302, and the LC circuits 814, 816, 834, 836, and 838 can be the same as the LC circuit 306. The battery module 200 may also include batteries, half-bridge circuits, and LC circuits that are not shown. In FIG. 8, charge is transferred from the battery cell 202 to the battery cell 204, from the battery cell 802 to the battery cell 806, and from the battery cell 824 to the battery cell 818. The multiple charge transfers can occur simultaneously. The control circuit 308 controls the transfers by setting the phases of the driver signals provided to the half-bridge circuits. In FIG. 8, the driver signals provided to the half-bridge circuit 304 are shifted right (delayed) relative to the driver signals provided to the half-bridge circuit 302 to transfer charge from the battery cell 202 to the battery cell 204.

In the charge transfer to the battery cell 806, the driver signals provided to the half-bridge circuit 810 are shifted right (delayed) relative to the driver signals provided to the half-bridge circuit 808. The driver signals provided to the half-bridge circuit 812 are shifted right (delayed) relative to the driver signals provided to the half-bridge circuit 810 to transfer charge from the battery cell 802 to the battery cell 806.

In the charge transfer to the battery cell 818, the driver signals provided to the half-bridge circuit 830 are shifted right (delayed) relative to the driver signals provided to the half-bridge circuit 832. The driver signals provided to the half-bridge circuit 828 are shifted right (delayed) relative to the driver signals provided to the half-bridge circuit 830 The driver signals provided to the half-bridge circuit 826 are shifted right (delayed) relative to the driver signals provided to the half-bridge circuit 828 to transfer charge from the battery cell 824 to the battery cell 818.

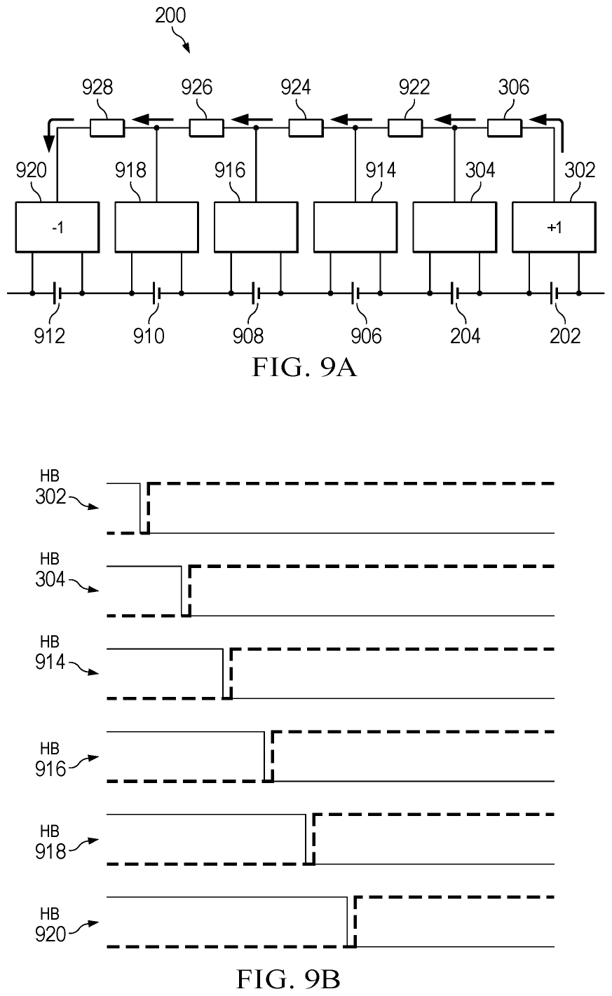

FIGS. 9A and 9B illustrate an example of charge transfer across six battery cells in the battery module 200. In FIG. 9A the battery module 200 includes battery cells 202, 204, 906, 908, 910, and 912 respectively coupled to half-bridge circuits 302, 304, 914, 916, 918, and 920. The LC circuits 306, 922, 924, 926, and 928 are coupled to the half-bridge circuits. The half-bridge circuits 914, 916, 918, and 920 can be the same as the half-bridge circuit 302, and the LC circuits 922, 924, 926, and 928 can be the same as the LC circuit 306. In FIG. 9A, charge is transferred from the battery cell 202 to the battery cell 912. FIG. 9B illustrates the switching in the half-bridge circuits 302, 304, 914, 916, 918, and 920 (e.g., the driver signals provided to the half-bridge circuits 302, 304, 914, 916, 918, and 920 by the control circuit 308). Switching in the half-bridge circuit 304 is delayed (phase shifted) relative to switching in the half-bridge circuit 302. Switching in the half-bridge circuit 914 is delayed (phase shifted) relative to switching in the half-bridge circuit 304. Switching in the half-bridge circuit 916 is delayed (phase shifted) relative to switching in the half-bridge circuit 914. Switching in the half-bridge circuit 918 is delayed (phase shifted) relative to switching in the half-bridge circuit 916. Switching in the half-bridge circuit 920 is delayed (phase shifted) relative to switching in the half-bridge circuit 918. Equal phase shift may be applied across the half-bridge circuits. For example, the phase shift between switching of the half-bridge circuit 302 and the half-bridge circuit 304 is the same as the phase shift between switching of the half-bridge circuit 304 and the half-bridge circuit 914, the half-bridge circuit 914 and the half-bridge circuit 916, the half-bridge circuit 916 and the half-bridge circuit 918, and the half-bridge circuit 918 and the half-bridge circuit 920.

With such switching arrangements, charge can be transferred from battery cell 202 to battery cell 204, from battery cell 204 to battery call 906, from battery cell 906 to battery cell 908, from battery cell 908 to battery cell 910, and from battery cell 910 to battery cell 912, which results in net charge transfer from battery cell 202 to battery cell 912. The multiple charge transfers can occur simultaneously. Such switch arrangements can also reduce the total inductance between a pair of half-bridge circuits that undergo charge transfer between them. For example, for the charge transfer from battery cell 202 to battery cell 204 through half-bridge circuits 302 and 304, the current flows through LC circuit 306 (and inductor 318) but not other LC circuits. Also, for the charge transfer from battery cell 910 to battery cell 912, the current flows through LC circuit 928 (and an inductor corresponding to inductor 318) but not other LC circuits. By limiting the total inductance, the ramp rate of inductor current during the phase shift of switching between the pairs of the half-bridges (e.g., within interval 406 of FIG. 4) can also increase, which can also increase the duration of power transfer interval 410 within each cycle, and improve the efficiency of charge transfer. On the other hand, if the intervening half-bridges between half-bridges 302 and 920 are not switched, a current flowing from half-bridge 302 to half-bridge 920 may experience the combined inductances of LC circuits 306, 922, 924, 926, and 928. With the increased total inductance, the ramp rate of inductor current during the phase shift of switching between half-bridges 302 and 920 can reduce, which reduces the duration of power transfer interval 410 within each cycle and degrades the efficiency of charge transfer. The switching frequency may also be reduced to provide longer time due to the reduced ramp rate of the inductor current, which may increase the size of the capacitors in the LC circuits between the half bridge circuits.

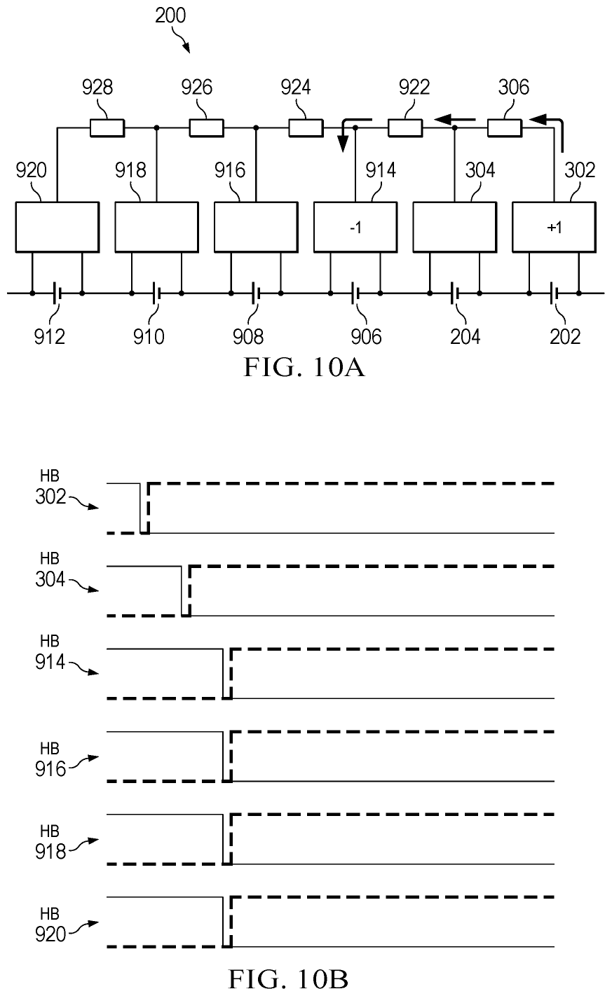

FIGS. 10A and 10B illustrate an example of charge transfer across three battery cells in the battery module 200. In FIG. 10A the battery module 200 is the same as shown in FIG. 9A. In FIG. 10A charge is transferred from the battery cell 202 to the battery cell 906. FIG. 10B illustrates the switching in the half-bridge circuits 302, 304, 914, 916, 918, and 920 (e.g., the driver signals provided to the half-bridge circuits 302, 304, 914, 916, 918, and 920 by the control circuit 308). Switching in the half-bridge circuit 304 is delayed (phase shifted) relative to switching in the half-bridge circuit 302. Switching in the half-bridge circuit 914 is delayed (phase shifted) relative to switching in the half-bridge circuit 304. Switching in the half-bridge circuits 916, 918, and 920 is a same phase as switching in the half-bridge circuit 914. With this switching, charge is transferred from the battery cell 202 to the battery cell 906, and little or no charge is transferred from the battery cell 202 to the battery cell 204, 908, 910, or 912.

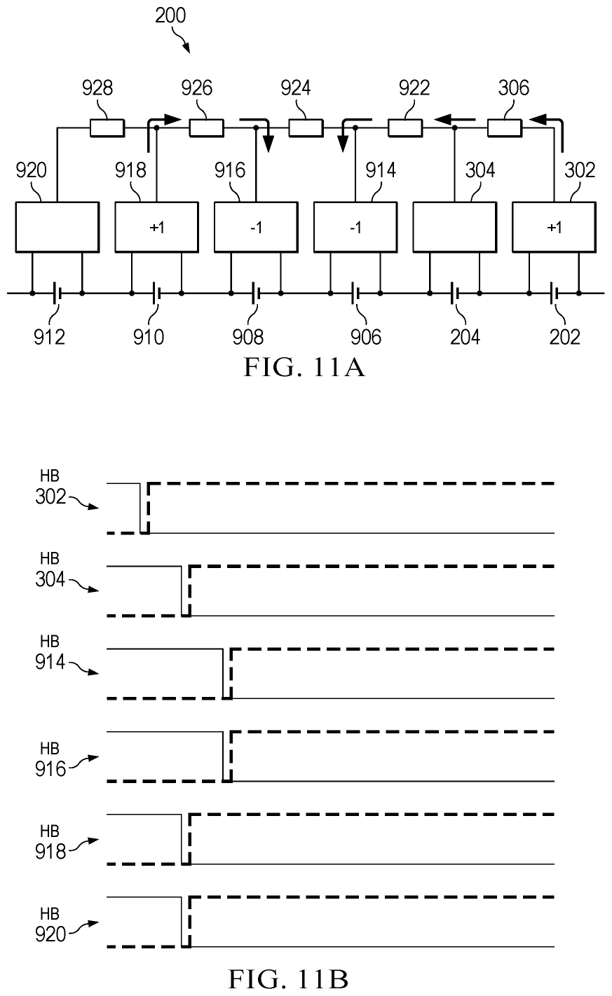

FIGS. 11A and 11B illustrate an example of charge transfer across three battery cells and two battery cells in the battery module 200. In FIG. 11A the battery module 200 is the same as shown in FIG. 9A. In FIG. 11A charge is transferred from the battery cell 202 to the battery cell 906, and from the battery cell 910 to the battery cell 908. The multiple charge transfers can occur simultaneously. FIG. 11B illustrates the switching in the half-bridge circuits 302, 304, 914, 916, 918, and 920 (e.g., the driver signals provided to the half-bridge circuits 302, 304, 914, 916, 918, and 920 by the control circuit 308). Switching in the half-bridge circuit 304 is delayed (phase shifted) relative to switching in the half-bridge circuit 302. Switching in the half-bridge circuit 914 is delayed (phase shifted) relative to switching in the half-bridge circuit 304. Switching in the half-bridge circuit 916 is a same phase as switching in the half-bridge circuit 914. Switching in the half-bridge circuits 918 and 920 is a same phase as switching in the half-bridge circuit 304. With this switching, charge is transferred from the battery cell 202 to the battery cell 906, and little or no charge is transferred from the battery cell 202 to the battery cell 204. Charge is also transferred from the battery cell 910 to the battery cell 908, and no charge is transferred to or from the battery cell 912.

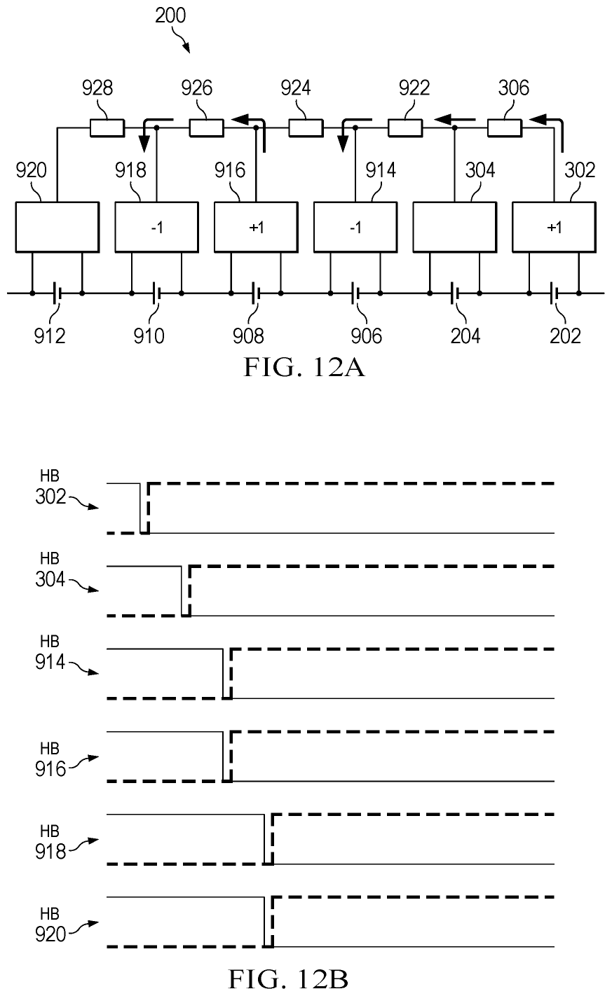

FIGS. 12A and 12B illustrate another example of charge transfer across three battery cells and two battery cells in the battery module 200. In FIG. 12A the battery module 200 is the same as shown in FIG. 9A. In FIG. 12A charge is transferred from the battery cell 202 to the battery cell 906, and from the battery cell 908 to the battery cell 910. The multiple charge transfers can occur simultaneously. FIG. 12B illustrates the switching in the half-bridge circuits 302, 304, 914, 916, 918, and 920 (e.g., the driver signals provided to the half-bridge circuits 302, 304, 914, 916, 918, and 920 by the control circuit 308). Switching in the half-bridge circuit 304 is delayed (phase shifted) relative to switching in the half-bridge circuit 302. Switching in the half-bridge circuit 914 is delayed (phase shifted) relative to switching in the half-bridge circuit 304. Switching in the half-bridge circuit 916 is a same phase as switching in the half-bridge circuit 914. Switching in the half-bridge circuits 918 and 920 is a same phase and is delayed (phase shifted) relative to switching in the half-bridge circuit 916. With this switching, charge is transferred from the battery cell 202 to the 906, and little or no charge is transferred from the battery cell 202 to the battery cell 204. Charge is also transferred from the battery cell 908 to the battery cell 910, and no charge is transferred to or from the battery cell 912.

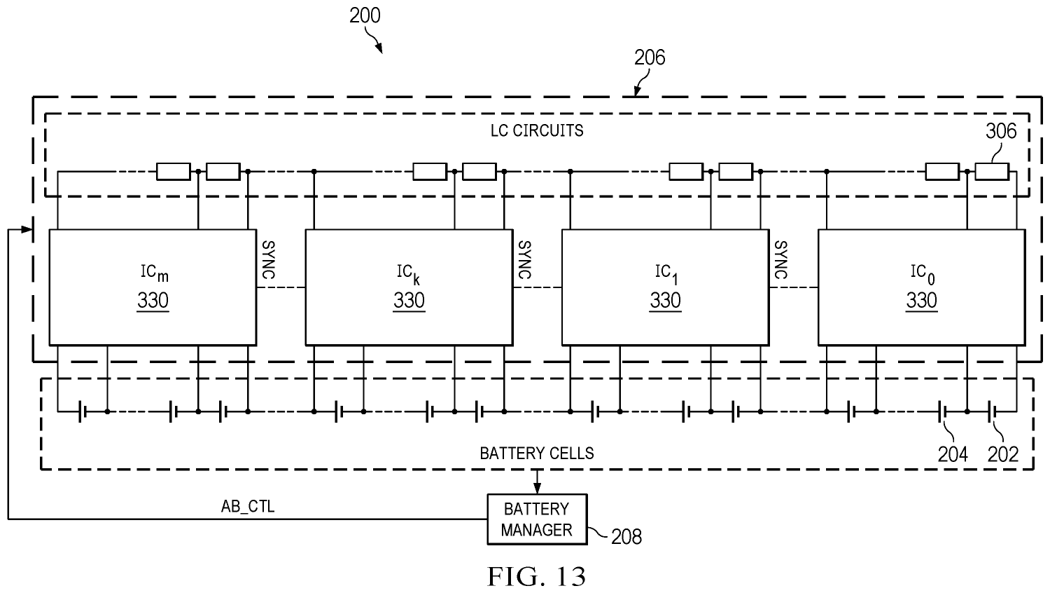

FIG. 13 is a block diagram of a portion of an example of the battery module 200. In FIG. 13, the battery module 200 includes multiple integrated circuits 330. Each integrated circuit 330 can include multiple half-bridge circuits (half-bridge circuits 302, 304, etc.). Each half-bridge circuit is coupled to a battery cell (e.g., battery cell 202, 204, etc.) and an LC circuit (e.g., an example of the LC circuit 306). Each integrated circuit 330 can provide a synchronization signal (labelled SYNC in FIG. 13) to a successive integrated circuit 330. The synchronization signal allows for synchronization of the timing (phasing) of the driver signals generated by the control circuit 308 of each integrated circuit 330. The battery manager circuit 208 can be coupled to each of the battery cells and to each integrated circuit 330 for measurement of battery cell parameters and communication of cell balancing parameters. Accordingly, the active cell balancing circuit 206 can set the phases of the driver signals generated in each of the integrated circuits 330 to transfer charge between batteries coupled to different instances of the integrated circuit 330.

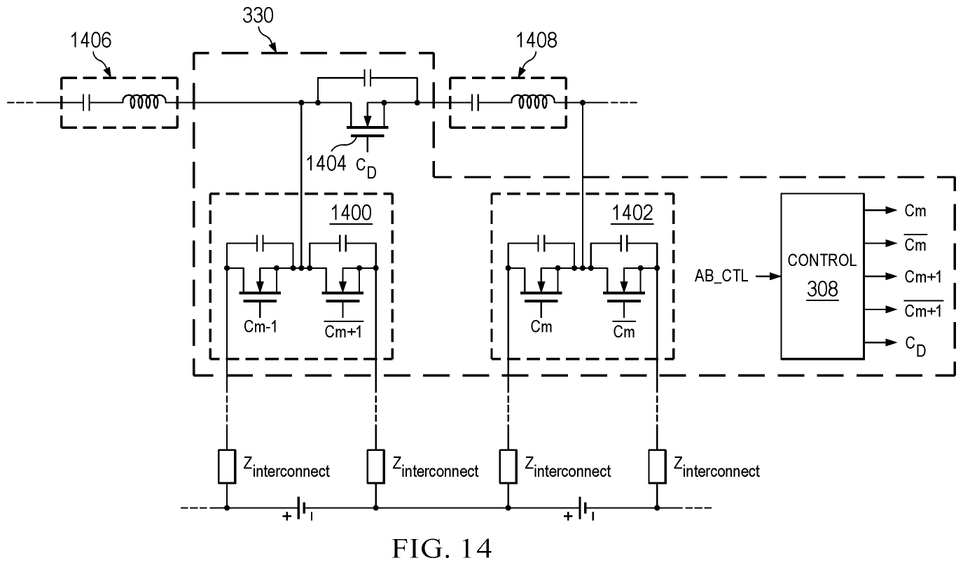

FIG. 14 is a schematic diagram of an example active cell balancing circuit that includes a disconnect switch coupled between LC circuits. In FIG. 14, the active cell balancing circuit includes half-bridge circuits 1400 and 1402, and a transistor 1404. The active cell balancing circuit may include more than two half-bridge circuits in some examples. The half-bridge circuits 1400 and 1402 can be the same as the half-bridge circuit 302. The LC circuits 1406 and 1408 can be the same as the LC circuit 306. The transistor 1404 is coupled between a switch node of the half-bridge circuit 1400 and a capacitor terminal of the active cell balancing circuit. For example, a first current terminal (e.g., source) of the transistor 1404 is coupled to a first capacitor terminal of the active cell balancing circuit and a second current terminal (e.g., drain) of the transistor 1404 is coupled to a switch node of the half-bridge circuit 1400. The LC circuit 1408 is coupled between the transistor 1404 and the switch node of the half-bridge circuit 1402. The LC circuit 1406 is coupled to the transistor 1404 and the switch node of the half-bridge circuit 1400. The active cell balancing circuit may include any number of instances of the transistor 1404. For example, the active cell balancing circuit may include an instance of the transistor 1404 coupled to the switch node of each half-bridge circuit, or an instance of the transistor 1404 coupled to the switch node of every other half-bridge circuit, or an instance of the transistor 1404 coupled to the switch node of every 4th half-bridge circuit, every 10th half-bridge circuit, etc. The half-bridge circuits, the transistor 1404, and the control circuit 308 can be included in the integrated circuit 330.

The transistor 1404 can be configured as a unidirectional switch or a bidirectional switch. The transistor 1404 allows the number of half-bridge circuits switched during charge transfer to be reduced in some examples. For example, in FIG. 10A, the half-bridge circuits 916, 918, and 920 are switched even though no charge is being transferred to the battery cells 908, 910, and 912. In an example of the active balancing circuit that includes a transistor 1404 between the half-bridge circuit 914 and the half-bridge circuit 916, the transistor 1404 can be turned off, and the half-bridge circuits 916, 918, and 920 need not be switched. The control circuit 308 includes an output coupled to a control terminal of the transistor 1404. The control circuit 308 provides a control signal C_{D} to control turn-on and turn-off of the transistor 1404 based on AB_CTL.

In some examples, the transistor 1404 can be coupled between the switching node of the half-bridge circuit and the LC circuits. For example, a first current terminal of the transistor 1404 can be coupled to the switching node of the 1400 and a second current terminal of the transistor 1404 can be coupled to both of the LC circuits 1406 and 1408 (e.g., second current terminal of the transistor 1404 can be coupled to the connection point of the LC circuits 1406 and 1408). In such examples, an instance of the transistor 1404 can be coupled to the switching node of each half-bridge circuit. The transistor 1404 of a selected half-bridge circuit can be turned off, and the transistors of the selected half-bridge circuit turned off, to enable transfer of charge between half-bridge circuits on either side of the selected half-bridge circuit while the selected half-bridge circuit remains idle (not switching).

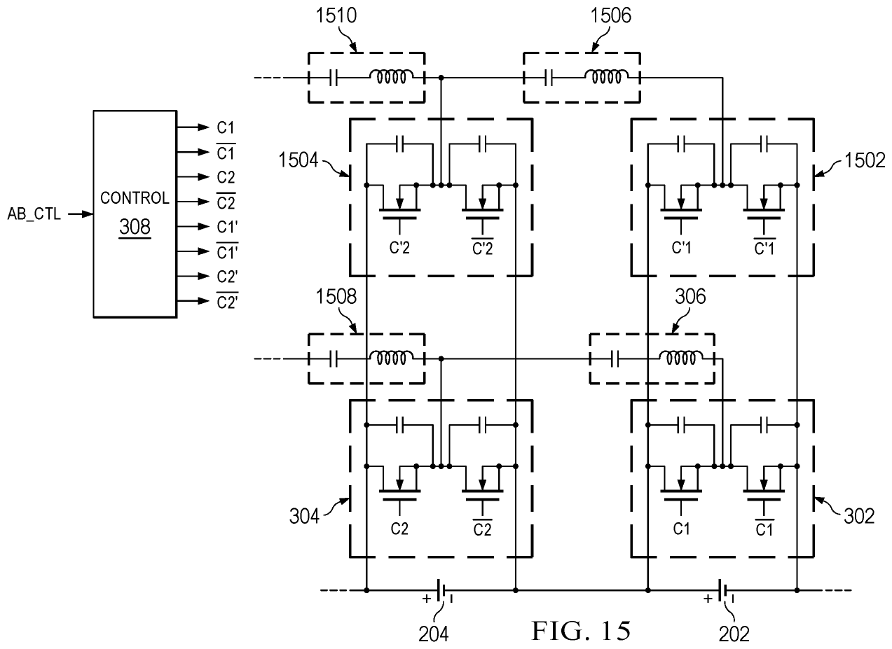

FIG. 15 is a schematic diagram of an example active cell balancing circuit configured for two-phase operation. In the active cell balancing circuit of FIG. 15, the half-bridge circuits 302 and 304, and the LC circuits 306 and 1508 are configured to operate (e.g., transfer charge between battery cells 202 and 204) in a first phase. The half-bridge circuits 1502 and 1504, and the LC circuits 1506 and 1508 are configured to operate (e.g., transfer charge between battery cells 202 and 204) in a second phase. The half-bridge circuits 302 and 1502 are coupled in parallel to the battery cell 202. The half-bridge circuits 304 and 1504 are coupled in parallel to the battery cell 204. The active cell balancing circuit may include any number of half-bridge circuits coupled in series in each phase. The half-bridge circuits 1502 and 1504 can be the same as the half-bridge circuit 302, and the LC circuits 1506, 1508, and 1510 can be the same as the LC circuit 306.

The control circuit 308 is coupled to the half-bridge circuits 302, 304, 1502, and 1504, and generates driver signals C1, C̅1̅, C2, C̅2̅, C1′, C̅1̅′̅, C2′, and C̅2̅′̅ that control switching of the half-bridge circuits. Switching of the half-bridge circuits 1502 and 1504 can be 180° out of phase with the switching of, respectively, the half-bridge circuits 302 and 304. The half-bridge circuits and the control circuit 308 can be incorporated in the integrated circuit 330.

Two-phase operation reduces the current stress on the transistors of the half-bridge circuits, and reduces dc current ripple, with little to no increase in circuit area relative to single phase implementations. Though not shown in FIG. 15, the active balancing circuit can include the input filter circuit 506 or the input filter circuit 606. Because the two phases operate 180° out of phase, two phase operation can reduce the AC component in the current flowing in the input filter.

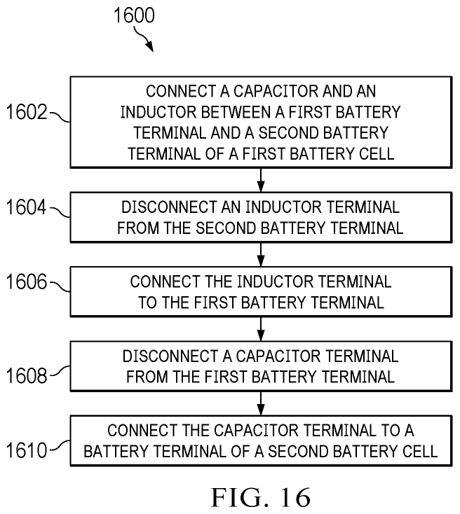

FIG. 16 is a flow diagram for an example method 1600 of active cell balancing. Though depicted sequentially as a matter of convenience, at least some of the actions shown can be performed in a different order and/or performed in parallel. Additionally, some implementations may perform only some of the actions shown. Operations of the method 1600 can be performed by an example of the active cell balancing circuit 206.

In block 1602, the capacitor 320 and the inductor 318 are connected between a first terminal (e.g., the positive terminal) of the battery cell 202 and a second terminal (e.g., the negative terminal) of the battery cell 202 by turning on the transistor 310 and the transistor 314. Connecting the capacitor 320 and the inductor 318 between the first battery terminal and the second battery terminal of battery cell 202 provides a first voltage (e.g., the voltage v₁ of the battery cell 202) across the capacitor 320. A capacitor terminal of the capacitor 320 is coupled to the first terminal of the battery cell 202 through the transistor 314, and an inductor terminal of the inductor 318 is coupled to the second terminal of the battery cell 202 through the transistor 310. The operations of block 1602 may be performed during interval 402 of FIG. 4.

In block 1604, the inductor terminal is disconnected from the second battery terminal of the battery cell 202 by turning off the transistor 310. The operations of block 1604 may be performed during interval 404 of FIG. 4.

In block 1606, the inductor terminal is connected to the first battery terminal of the battery cell 202 by turning on the transistor 312, and the voltage across the capacitor 320 is provided across the inductor 318. The operations of block 1606 may be performed during interval 406 of FIG. 4.

In block 1608, the capacitor terminal is disconnected from the first battery terminal of the battery cell 202 by turning off the transistor 314. The operations of block 1608 may be performed during interval 408 of FIG. 4.

In block 1610, the capacitor terminal is connected to a battery terminal (e.g., the positive terminal) of the battery cell 204 by turning on the transistor 316. Connecting the capacitor terminal to the third battery terminal of the battery cell 204 transfers charge from the capacitor 320 (e.g., charge from the battery cell 202 stored on the capacitor 320 in block 1602 to the battery cell 204. The rate of charge transfer can be based on the first voltage and an inductance of the inductor 318. The operations of block 1610 may be performed during interval 410 of FIG. 4.

In the method 1600, the control circuit 308 may determine a delay interval, and apply the delay interval to connect the capacitor terminal to the third battery terminal with respect to the connection of the inductor terminal to the first battery terminal. The delay interval can be determined based on a target amount of the charge to be transferred from the battery cell 202 to the battery cell 204.

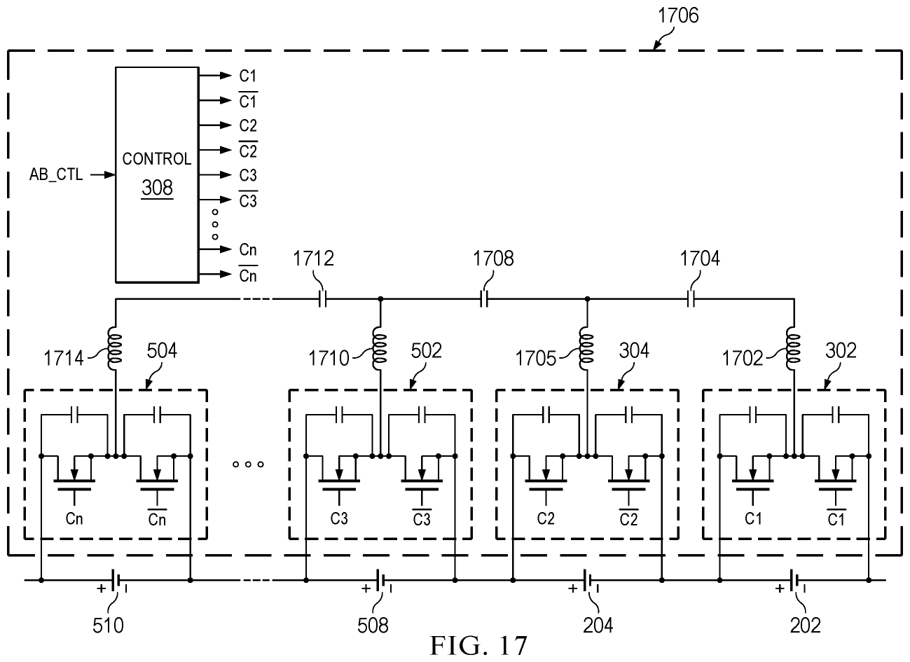

FIG. 17 is a schematic diagram of another active cell balancing circuit 1706. The active cell balancing circuit 1706 includes the half-bridge circuits 302, 304, 502, and 504 respectively coupled to the battery cells 202, 204, 508, and 510. Examples of the active cell balancing circuit 1706 can include any number of half-bridge circuits coupled in series. The half-bridge circuits may be included in the integrated circuit 330. The active cell balancing circuit 1706 is similar to the active cell balancing circuit 206, but the arrangement of the inductors in the active cell balancing circuit 1706 differs from that of the active cell balancing circuit 206. In the active cell balancing circuit 206, the inductors and capacitors are in series. In the active cell balancing circuit 1706, the capacitors are in series, and the inductors are coupled between the switch nodes of the half-bridge circuits and the series capacitors. Accordingly, in the active cell balancing circuit 1706, the path between two half-bridge circuits, separated by any number of battery cells and half-bridge circuits, may include only capacitors and two inductors. Such arrangements can reduce losses caused by the inductors and facilitate power transfer over longer distances (e.g., between battery cells separated by a large number of battery cells). In some examples, the inductors used in the active cell balancing circuit 1706 may have half the inductance of the inductors used in the active cell balancing circuit 206. Though not shown in FIG. 17, the active cell balancing circuit 1706 can also include the input filter circuit 506 or the input filter circuit 606.

An inductor is coupled to the switch node of each of the half-bridge circuits. A first terminal of the inductor 1702 is coupled to the switch node of the half-bridge circuit 302. A first terminal of the inductor 1705 is coupled to the switch node of the half-bridge circuit 304. A first terminal of the inductor 1710 is coupled to the switch node of the half-bridge circuit 502. A first terminal of the inductor 1714 is coupled to the switch node of the 510. A capacitor is coupled between the inductors coupled to the switch nodes of successive half-bridge circuits. The capacitor 1704 is coupled between the second terminal of the inductor 1702 and the second terminal of the inductor 1705. The capacitor 1708 is coupled between the second terminal of the inductor 1705 and the second terminal of the inductor 1710. The capacitor 1712 is coupled between a second terminal of the inductor 1710 and a second terminal of another inductor (e.g., the inductor 1714).

The control circuit 308 is coupled to the half-bridge circuits 302, 304, 502, and 504. The control circuit 308 generates the driver signals that control switching in the half-bridge circuits. The half-bridge switching to transfer charge between two batteries can be the same as described in FIG. 4. In the active cell balancing circuit 206 (e.g., as shown in FIG. 5), the control circuit 308 switches all of the half-bridge circuits when charge is to be transferred between any two battery cells (see e.g., FIGS. 10A and 10B). In the active cell balancing circuit 1706, because only two inductors are in series between a pair of half-bridge circuits, only the half-bridge circuits transferring charge can be switched, and the intervening half-bridges between the pair of half-bridge need not be switched. For example, to transfer charge from the battery cell 202 to the battery cell 508, the control circuit 308 can cause the half-bridge circuit 302 and the half-bridge circuit 502 to switch according to the timing of FIG. 4, and half-bridge circuit 304, the half-bridge circuit 504, and any other half-bridge circuits of the active cell balancing circuit 1706 do not switch. As discussed above with FIG. 9A, the intervening half-bridges may be switched (and with the switching equally phase-shifted) to reduce the total inductance along the current path between a pair of half-bridges involved in charge transfer. Such arrangements can be omitted by limiting the number of inductors between any pair of half-bridges active cell balancing circuit 1706 to two.

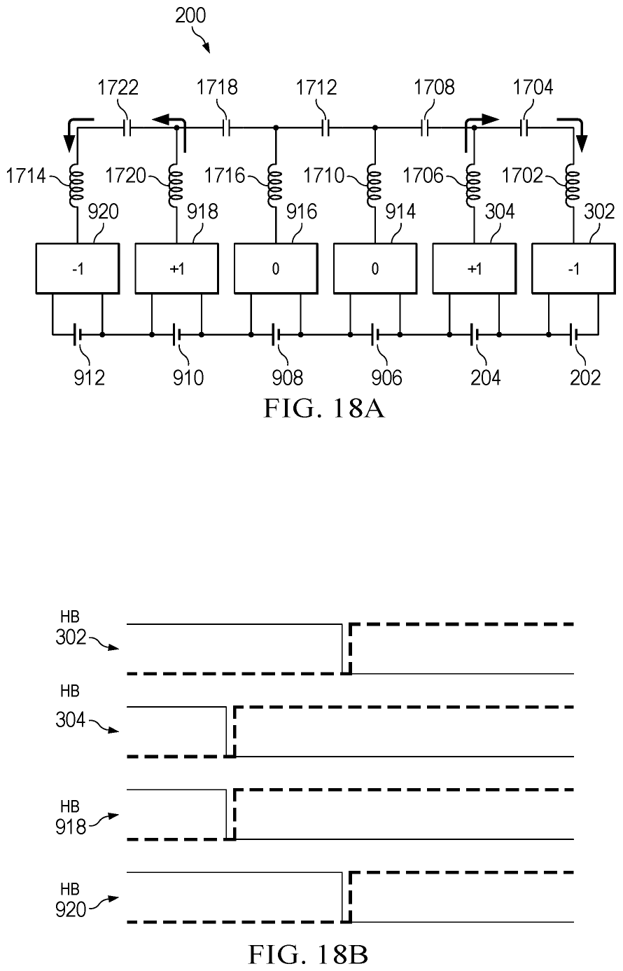

FIGS. 18A and 18B illustrate an example of charge transfer between different pairs of battery cells in a battery module using an example of the active cell balancing circuit 1706. In FIG. 18A the battery module includes battery cells 202, 204, 906, 908, 910, and 912 coupled to half-bridge circuits 302, 304, 914, 916, 918, and 920. The half-bridge circuits 914, 916, 918, and 920 can be the same as the half-bridge circuit 302. One of the inductors 1702, 1705, 1710, 1716, 1720, or 1714 is coupled to the switch node of each half-bridge circuit, and one of the capacitors 1704, 1708, 1712, 1718, or 1722 is coupled between adjacent inductors. In FIG. 18A, charge is transferred from the battery cell 204 to the battery cell 202, and from the battery cell 910 to the battery cell 912. The multiple charge transfers can occur simultaneously. FIG. 18B illustrates the switching in the half-bridge circuits 302, 304, 918, and 920 (e.g., the driver signals provided to the half-bridge circuits 302, 304, 914, 916, 918, and 920 by the control circuit 308). Switching in the half-bridge circuit 302 is delayed (phase shifted) relative to switching in the half-bridge circuit 304. Switching in the half-bridge circuit 920 is delayed (phase shifted) relative to switching in the half-bridge circuit 918. Switching in the half-bridge circuit 918 can be a same phase as switching in the half-bridge circuit 304. The half-bridge circuits 914 and 916 are idle (not switched) With this switching, charge is transferred from the battery cell 204 to the battery cell 202, and from the battery cell 910 to the battery cell 912. No charge is transferred to or from the battery cell 906 or the battery cell 908. In some examples, the half-bridge circuits coupled to sinking battery cells can be switched in phase, and the phase shift applied to half-bridge circuits coupled to sourcing battery cells can be adjusted to transfer charge.

In the active cell balancing circuit 1706, as the number of capacitors coupled in series between a sourcing half-bridge circuit and a sinking half-bridge circuit increases, the capacitance decreases, and the resonant frequency of the LC network formed by the inductors and capacitors increases. The control circuit 308 can switch the half-bridge circuits at a fixed switching frequency in some examples. The active cell balancing circuit 1706 transfers power if the switching frequency is higher than the resonant frequency of the LC network. Accordingly, the number of capacitors coupled in series between sourcing and sinking half-bridge circuits may be limited so that the switching frequency can stay higher than the resonant frequency of the LC network.

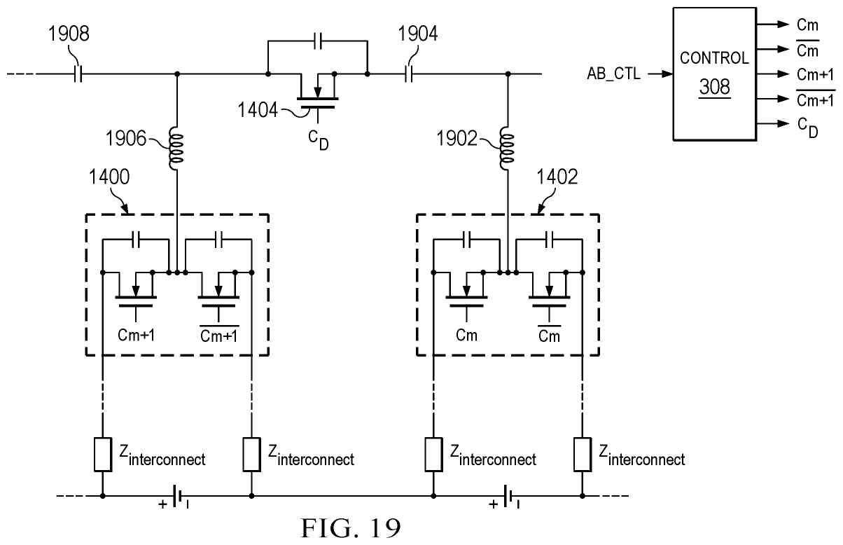

FIG. 19 is a schematic diagram of an active cell balancing circuit that includes a disconnect switch coupled between capacitors. The disconnect switch can be opened to reduce the number of capacitors coupled in series. The half-bridge circuits and disconnect switches of FIG. 19 are similar to those shown in FIG. 14. In FIG. 19, the active cell balancing circuit includes half-bridge circuits 1400 and 1402, inductors 1902 and 1906, capacitors 1904 and 1908, and a transistor 1404. The active cell balancing circuit may include more than two half-bridge circuits in some examples. A first terminal of the inductor 1902 is coupled to the switch node of the half-bridge circuit 1402, and a first terminal of the inductor 1906 is coupled to the switch node of the half-bridge circuit 1400. The transistor 1404 is coupled between the second terminal of the inductor 1906 and the capacitor 1904. The capacitor 1904 is coupled between the transistor 1404 and the second terminal of the inductor 1902. The capacitor 1908 is coupled to the second terminal of the inductor 1906.

The active cell balancing circuit may include any number of instances of the transistor 1404. For example, the active cell balancing circuit may include an instance of the transistor 1404 for each half-bridge circuit, or an instance of the transistor 1404 for every other half-bridge circuit, or an instance of the transistor 1404 for every 4th half-bridge circuit, every tenth half-bridge circuit, etc. The half-bridge circuits, the transistor 1404, and the control circuit 308 can be included in the integrated circuit 330.

The control circuit 308 includes an output coupled to a control terminal of the transistor 1404. The control circuit 308 provides a control signal C_{D} to control turn-on and turn-off of the transistor 1404 based on AB_CTL. The transistor 1404 allows the number of the number of series coupled capacitors (e.g., capacitors 1904 and 1908) to be controlled.

In some examples, half-bridge 1400 can be a first set of M half-bridges that are coupled together by M−1 instances of capacitors, and half-bridge 1402 can be another set of M half-bridges coupled by M−1 instances of capacitors, similar to as shown in FIG. 18A. By enabling or disabling transistor 1404, the total number of capacitors in a current conduction path between a pair of half-bridges undergoing charge transfer can be limited to M−1, which can set an upper bound of the resonant frequency to be below the switching frequency. Also, transistor 1404 can be disabled if no charge is to be transferred between the first and second sets of M half-bridges, which can avoid switching all the intervening half-bridges between first and second sets of M half-bridges.

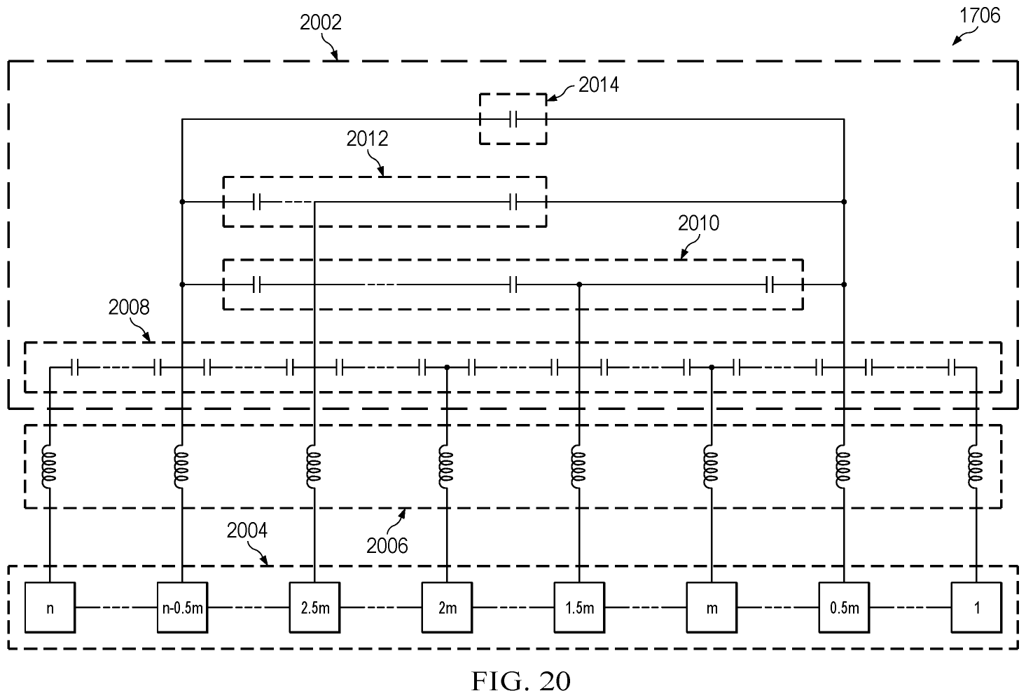

FIG. 20 is a block diagram of an example of the active cell balancing circuit 1706 that includes a network of parallel capacitors 2002. In FIG. 20, the active cell balancing circuit 1706 includes n half-bridge circuits 2004, and an inductor 2006 coupled to the switch node of each half-bridge circuit. The network of parallel capacitors 2002 include a first set of capacitors 2008, a second set of capacitors 2010, a third set of capacitors 2012, and a fourth set of capacitors 2014. The first set of capacitors 2008 is coupled to the inductors as shown in FIG. 17. The first set of capacitors 2008 can include a capacitor for each half-bridge circuit. The second set of capacitors 2010 is coupled in parallel with the first set of capacitors 2008. The second set of capacitors 2010 can include a capacitor coupled in parallel with m capacitors of the first set of capacitors 2008. The third set of capacitors 2012 is coupled in parallel with the second set of capacitors 2010 and the first set of capacitors 2008. The third set of capacitors 2012 can include a capacitor coupled in parallel with 2 m capacitors of the first set of capacitors 2008. The fourth set of capacitors 2014 can include a capacitor coupled in parallel with n capacitors of the first set of capacitors 2008. Other examples of the network of parallel capacitors 2002 may include a different number of parallel levels of capacitors, and the capacitors of each level may span a different number of capacitors of the first set of capacitors 2008.

The network of parallel capacitors 2002 increases the capacitance between two half-bridge circuits, which decreases the resonant frequency of the LC network formed by the network of parallel capacitors 2002 and the inductors 2006, and enables power transfer between half-bridge circuits that may be separated by too small a capacitance using only the first set of capacitors 2008.

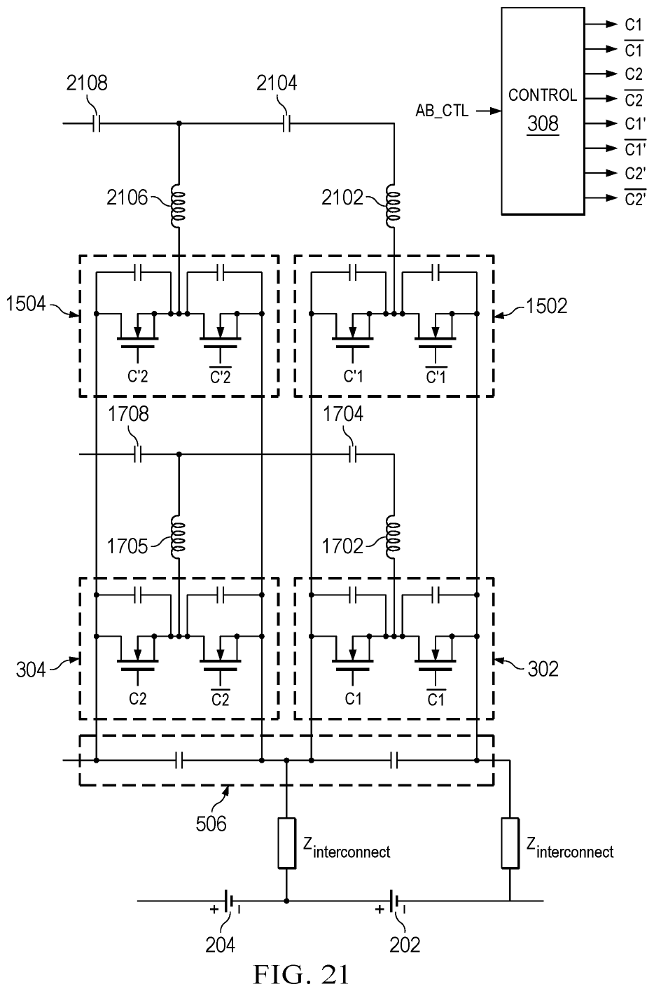

FIG. 21 is a schematic diagram of an example active cell balancing circuit configured for two-phase operation. The active cell balancing circuit of FIG. 21 is similar to the active cell balancing circuit of FIG. 15, but uses the LC arrangement of the active cell balancing circuit 1706 rather than the LC arrangement of the LC circuit 306. In the active cell balancing circuit of FIG. 21, the half-bridge circuits 302 and 304, the inductors 1702 and 1705, and the capacitors 1704 and 1708 are configured to operate as a first phase. The half-bridge circuits 1502 and 1504, the inductors 2102 and 2106, and the capacitors 2104 and 2108 are configured to operate as a second phase. The half-bridge circuits 302 and 1502 are coupled in parallel with the battery cell 202. The half-bridge circuits 304 and 1504 are coupled in parallel with the battery cell 204. The active cell balancing circuit may include any number of half-bridge circuits coupled in series in each phase. In FIG. 21, the input filter circuit 506 is also shown. Some examples may include the input filter circuit 606 in place of the input filter circuit 506.

The control circuit 308 is coupled to the half-bridge circuits 302, 304, 1502, and 1504, and generates driver signals C1, C̅1̅, C2, C̅2̅, C1′, C̅1̅′̅, C2′, and C̅2̅′̅ that control switching of the half-bridge circuits. Switching of the half-bridge circuits 1502 and 1504 can be 180° out of phase with the switching of the half-bridge circuits 302 and 304. The half-bridge circuits and the control circuit 308 can be incorporated in the integrated circuit 330.

Two-phase operation reduces the current stress on the transistors of the half-bridge circuits with little to no increase in circuit area relative to single phase implementations. Because the two phases operate 180° out of phase, two phase operation can reduce the AC component of the current flowing in the input filter.

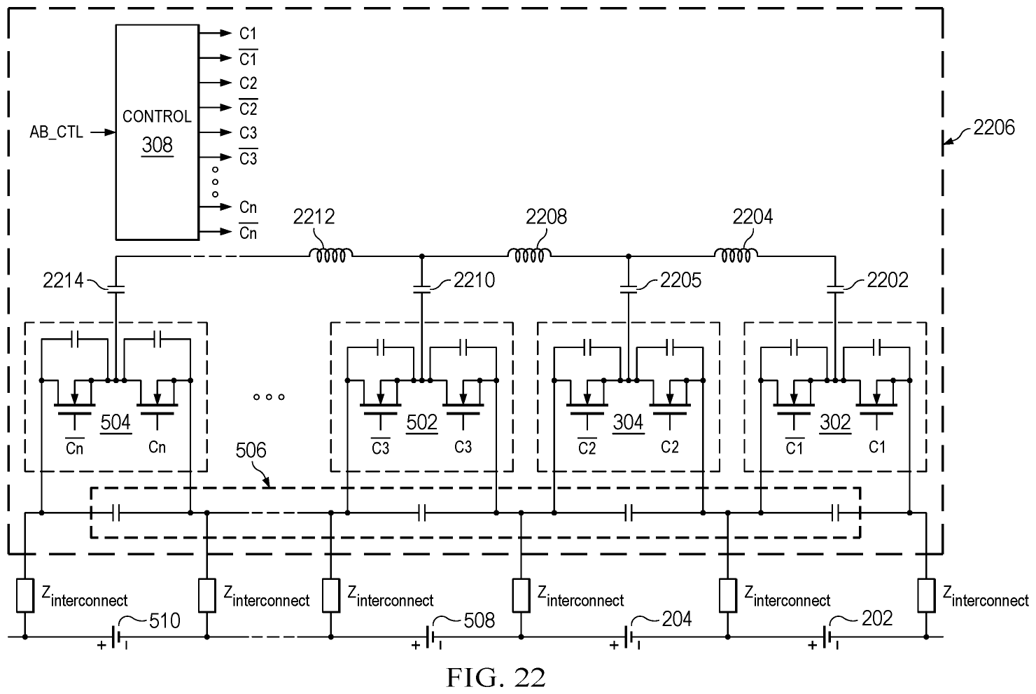

FIG. 22 is a schematic diagram of another example active cell balancing circuit 2206. The active cell balancing circuit 2206 includes the half-bridge circuits 302, 304, 502, and 504 respectively coupled to the battery cells 202, 204, 508, and 510. Examples of the active cell balancing circuit 2206 can include any number of half-bridge circuits coupled in series. The half-bridge circuits may be included in the integrated circuit 330. The active cell balancing circuit 2206 is similar to the active cell balancing circuit 1706, but the inductors and capacitors have been swapped relative to the active cell balancing circuit 1706. In the active cell balancing circuit 2206, the inductors are coupled in series, and the capacitors are coupled between the switch nodes of the half-bridge circuits and the series inductors. Accordingly, in the active cell balancing circuit 2206, the path between two half-bridge circuits includes only inductors and two capacitors, which can decrease the reduction in capacitance resulting from capacitors coupled in series and the resulting increase in the resonant frequency. The active cell balancing circuit 2206 can also include the input filter circuit 506 or the input filter circuit 606. In FIG. 22, the active cell balancing circuit 2206 is shown including the input filter circuit 506.

In the active cell balancing circuit 2206, capacitor is coupled to the switch node of each of the half-bridge circuits. A first terminal of the capacitor 2202 is coupled to the switch node of the half-bridge circuit 302. A first terminal of the capacitor 2205 is coupled to the switch node of the half-bridge circuit 304. A first terminal of the capacitor 2210 is coupled to the switch node of the half-bridge circuit 502. A first terminal of the capacitor 2214 is coupled to the switch node of the 510. An inductor is coupled between the capacitors coupled to the switch nodes of successive half-bridge circuits. The inductor 2204 is coupled between the second terminal of the 2202 and the second terminal of the capacitor 2205. The inductor 2208 is coupled between the second terminal of the capacitor 2205 and the second terminal of the 2210. The inductor 2212 is coupled between a second terminal of the 2210 and a second terminal of another capacitor (e.g., the capacitor 2214).

The control circuit 308 is coupled to the half-bridge circuits 302, 304, 502, and 504. The control circuit 308 generates the driver signals that control switching in the half-bridge circuits. The half-bridge switching to transfer charge between two batteries can be the same as described in FIG. 4. In the active cell balancing circuit 2206, like the active cell balancing circuit 206, the control circuit 308 switches all of the half-bridge circuits when charge is to be transferred between any two battery cells (see e.g., FIGS. 9A/9B, 10A/10B, 11A/11B, and 12A/12B).

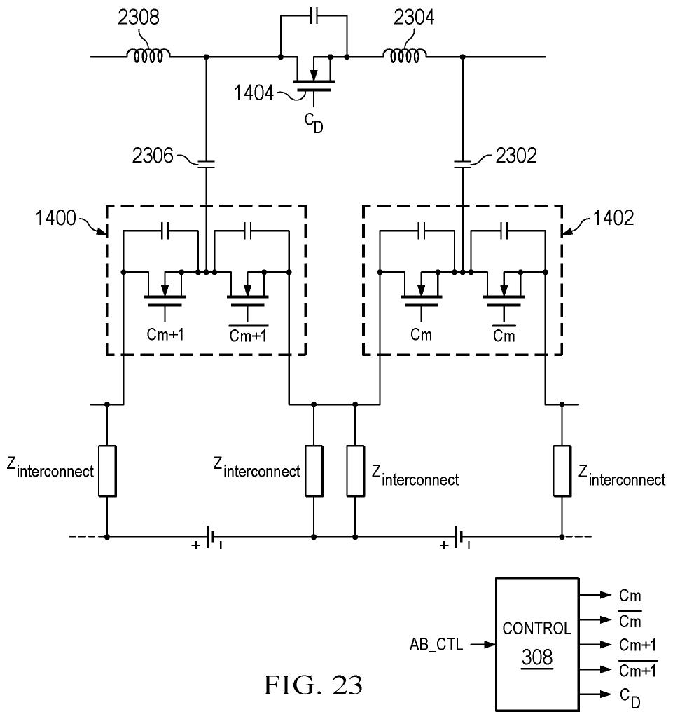

FIG. 23 is a schematic diagram of an example of the active cell balancing circuit 2206 that includes a disconnect switch. The disconnect switch can be opened to reduce the number of inductors coupled in series. The half-bridge circuits and disconnect switches of FIG. 23 are similar to those shown in FIG. 14. In FIG. 23, the active cell balancing circuit includes half-bridge circuits 1400 and 1402, capacitors 2302 and 2306, inductors 2304 and 2308, and a transistor 1404. The active cell balancing circuit may include more than two half-bridge circuits, capacitors, and inductors in some examples. A first terminal of the capacitor 2302 is coupled to the switch node of the half-bridge circuit 1402, and a first terminal of the capacitor 2306 is coupled to the switch node of the half-bridge circuit 1400. The transistor 1404 is coupled between the second terminal of the capacitor 2306 and the inductor 2304. The inductor 2304 is coupled between the transistor 1404 and the second terminal of the capacitor 2302. The inductor 2308 is coupled to the second terminal of the capacitor 2306.

The active cell balancing circuit may include any number of instances of the transistor 1404. For example, the active cell balancing circuit may include an instance of the transistor 1404 for each half-bridge circuit (between each adjacent pair of half-bridge circuits), or an instance of the transistor 1404 for every other half-bridge circuit, or an instance of the transistor 1404 for every 4th half-bridge circuit, every tenth half-bridge circuit, etc. The half-bridge circuits, the transistor 1404, and the control circuit 308 can be included in the integrated circuit 330.

The control circuit 308 includes an output coupled to a control terminal of the transistor 1404. The control circuit 308 provides a control signal C_{D} to control turn-on and turn-off of the transistor 1404 based on AB_CTL. The transistor 1404 allows the number of the number of series coupled inductors (e.g., inductors 2304 and 2308) to be controlled, and the number of half-bridge circuits switched during charge transfer to be reduced in some examples as explained with reference to FIG. 14.

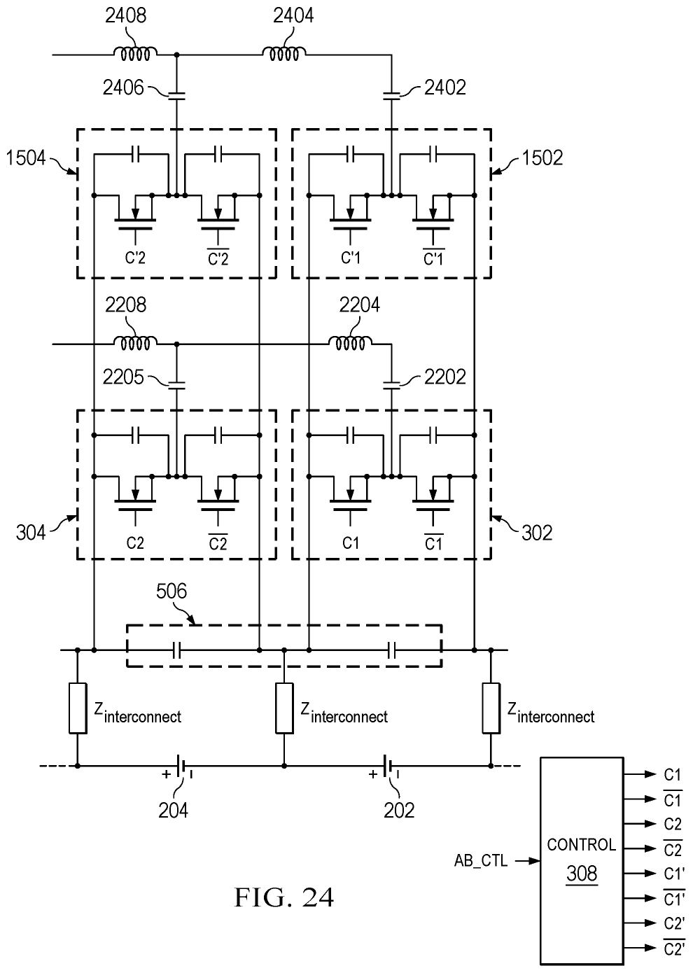

FIG. 24 is a schematic diagram of an active cell balancing circuit configured for two-phase operation based on the active cell balancing circuit 2206. The active cell balancing circuit of FIG. 24 is similar to the active cell balancing circuit of FIG. 15, but uses the LC arrangement of the active cell balancing circuit 2206 rather than the LC arrangement of the active cell balancing circuit 206. In the active cell balancing circuit of FIG. 24, the half-bridge circuits 302 and 304, the capacitors 2202 and 2205, and the inductors 2204 and 2208 are configured to operate as a first phase. The half-bridge circuits 1502 and 1504, the capacitors 2402 and 2406, and the inductors 2404 and 2408 are configured to operate as a second phase. The half-bridge circuits 302 and 1502 are coupled in parallel with the battery cell 202. The half-bridge circuits 304 and 1504 are coupled in parallel with the battery cell 204. The active cell balancing circuit may include any number of half-bridge circuits coupled in series in each phase. In FIG. 24, the input filter circuit 506 is also shown. Some examples may include the input filter circuit 606 in place of the input filter circuit 506.

The control circuit 308 is coupled to the half-bridge circuits 302, 304, 1502, and 1504, and generates driver signals C1, C̅1̅, C2, C̅2̅, C1′, C̅1̅′̅, C2′, and C̅2̅′̅ that control switching of the half-bridge circuits. The control circuit 308 can generate the driver signals such that switching of the half-bridge circuits 1502 and 1504 can be 180° out of phase with the switching of the half-bridge circuits 302 and 304. The half-bridge circuits and the control circuit 308 can be incorporated in the integrated circuit 330.

Two-phase operation reduces the current stress on the transistors of the half-bridge circuits with little to no increase in circuit area relative to single phase implementations. Because the two phases operate 180° out of phase, two phase operation can reduce the AC component of the current flowing in the input filter.

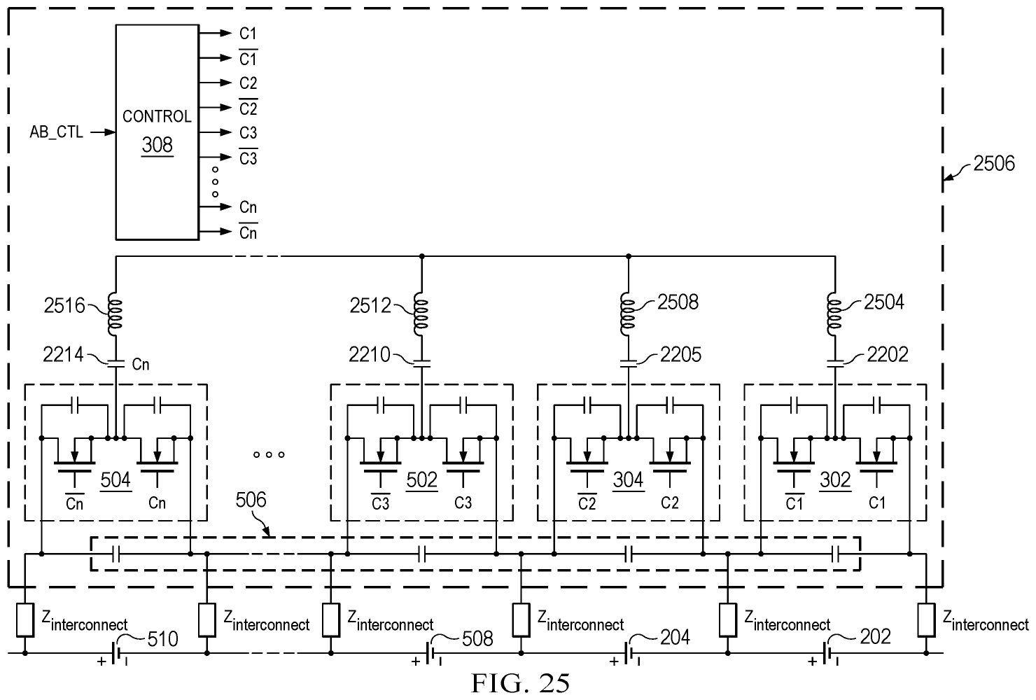

FIG. 25 is a schematic diagram of another example active cell balancing circuit 2506. The active cell balancing circuit 2506 includes the half-bridge circuits 302, 304, 502, and 504 respectively coupled to the battery cells 202, 204, 508, and 510. Examples of the active cell balancing circuit 2506 can include any number of half-bridge circuits coupled in series. The half-bridge circuits may be included in the integrated circuit 330. The active cell balancing circuit 2506 is similar to the active cell balancing circuit 2206, but in the active cell balancing circuit 2506 the inductors are coupled in series with capacitors to the switch nodes of the half-bridge circuits. Accordingly, in the active cell balancing circuit 2506, the path between two half-bridge circuits may include only two inductors and two capacitors. The active cell balancing circuit 2506 can also include the input filter circuit 506 or the input filter circuit 606. In FIG. 25, the active cell balancing circuit 2506 is shown as including the input filter circuit 506.

A capacitor is coupled to the switch node of each of the half-bridge circuits. A first terminal of the capacitor 2202 is coupled to the switch node of the half-bridge circuit 302. A first terminal of the capacitor 2205 is coupled to the switch node of the half-bridge circuit 304. A first terminal of the capacitor 2210 is coupled to the switch node of the half-bridge circuit 502. A first terminal of the capacitor 2214 is coupled to the switch node of the 510.

An inductor is coupled in series with each capacitor. A first terminal of the inductor 2504 is coupled to the second terminal of the capacitor 2202. A first terminal of the inductor 2508 is coupled to the second terminal of the capacitor 2205. A first terminal of the inductor 2512 is coupled to the second terminal of the capacitor 2210. A first terminal of the inductor 2516 is coupled to the second terminal of the capacitor 2214. A second terminal of the inductor 2504 is coupled to a second terminal of the inductor 2508, a second terminal of the inductor 2512, and a second terminal of the inductor 2516.

The control circuit 308 is coupled to the half-bridge circuits 302, 304, 502, and 504. The control circuit 308 generates the driver signals that control switching in the half-bridge circuits. The half-bridge switching to transfer charge between two batteries can be the same as described in FIG. 18A/18B. In the active cell balancing circuit 2506, like the active cell balancing circuit 1706, the control circuit 308 can switch only the sourcing and sinking half-bridge circuits when charge is to be transferred between any two battery cells.

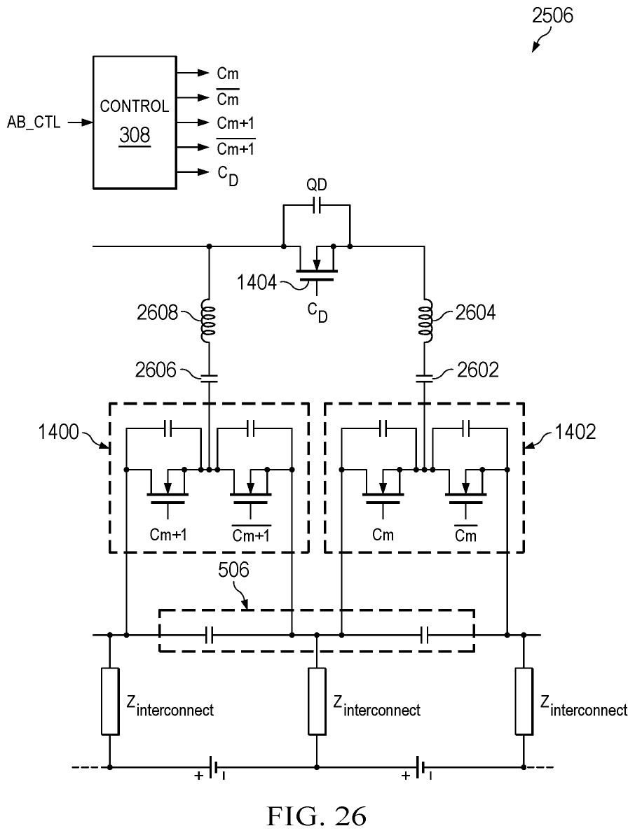

FIG. 26 is a schematic diagram of an example of the active cell balancing circuit 2506 that includes a disconnect switch. The disconnect switch can be opened to isolate a selected set of half-bridge circuits. The half-bridge circuits and disconnect switches of FIG. 26 are similar to those shown in FIG. 14. In FIG. 26, the active cell balancing circuit includes half-bridge circuits 1400 and 1402, capacitors 2602 and 2606, inductors 2604 and 2608, and a transistor 1404. The active cell balancing circuit may include more than two half-bridge circuits in some examples. A first terminal of the capacitor 2602 is coupled to the switch node of the half-bridge circuit 1402, and a first terminal of the capacitor 2606 is coupled to the switch node of the half-bridge circuit 1400. The inductor 2604 is coupled in series with the capacitor 2602, and the inductor 2608 is coupled in series with the capacitor 2606. A first terminal of the 2608 is coupled to the second terminal of the 2602, and a first terminal of the inductor 2608 is coupled to the second terminal of the capacitor 2606. The transistor 1404 is coupled between the second terminal of the 2604 and the second terminal of the inductor 2608.

The active cell balancing circuit 2506 may include any number of instances of the transistor 1404. For example, the active cell balancing circuit may include an instance of the transistor 1404 for each half-bridge circuit (between each adjacent pair of half-bridge circuits), or an instance of the transistor 1404 for every other half-bridge circuit, or an instance of the transistor 1404 for every 4th half-bridge circuit, every tenth half-bridge circuit, etc. The half-bridge circuits, the transistor 1404, and the control circuit 308 can be included in the integrated circuit 330.

The control circuit 308 includes an output coupled to a control terminal of the transistor 1404. The control circuit 308 provides a control signal C_{D} to control turn-on and turn-off of the transistor 1404 based on AB_CTL. The transistor 1404 allows the number of the number of half-bridge circuits coupled through the LC circuits to be selectively controlled.

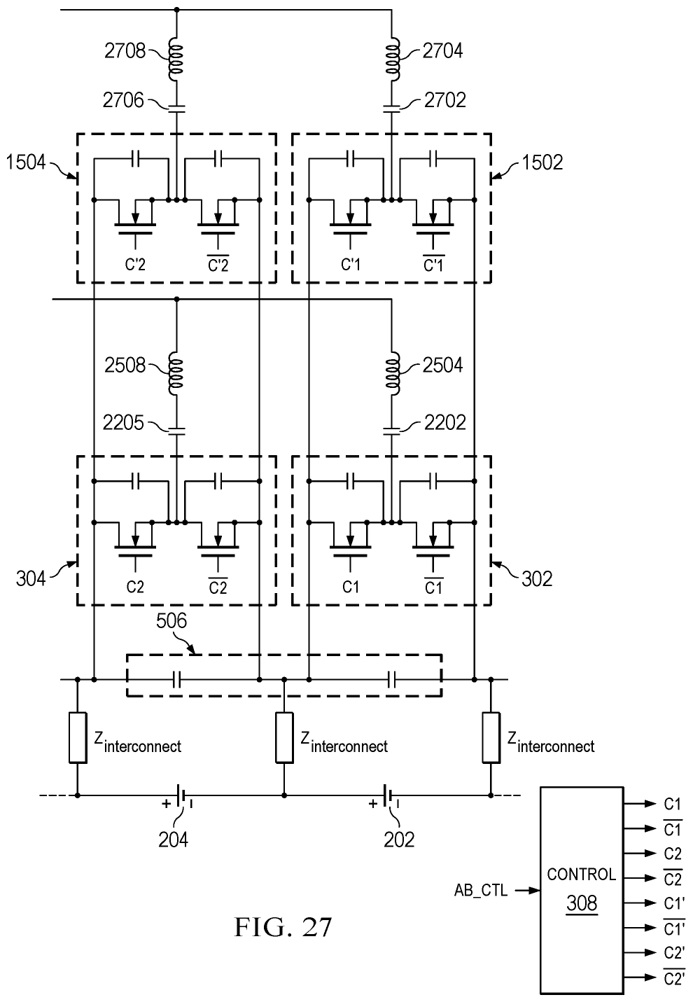

FIG. 27 is a schematic diagram of an active cell balancing circuit configured for two-phase operation based on the active cell balancing circuit 2506. The active cell balancing circuit of FIG. 27 is similar to the active cell balancing circuit of FIG. 15, but uses the LC arrangement of the active cell balancing circuit 2506 rather than the LC arrangement of the active cell balancing circuit 206. In the active cell balancing circuit of FIG. 24, the half-bridge circuits 302 and 304, the capacitors 2202 and 2205, and the inductors 2504 and 2508 are configured to operate as a first phase. The half-bridge circuits 1502 and 1504, the capacitors 2702 and 2706, and the inductors 2704 and 2708 are configured to operate as a second phase. The half-bridge circuits 302 and 1502 are coupled in parallel with the battery cell 202. The half-bridge circuits 304 and 1504 are coupled in parallel with the battery cell 204. The active cell balancing circuit may include any number of half-bridge circuits coupled in series in each phase. In FIG. 27, the input filter circuit 506 is also shown. Some examples may include the input filter circuit 606 in place of the input filter circuit 506.

The control circuit 308 is coupled to the half-bridge circuits 302, 304, 1502, and 1504, and generates driver signals C1, C̅1̅, C2, C̅2̅, C1′, C̅1̅′̅, C2′, and C̅2̅′̅ that control switching of the half-bridge circuits. The control circuit 308 can generate the driver signals such that switching of the half-bridge circuits 1502 and 1504 can be 180° out of phase with the switching of the half-bridge circuits 302 and 304. The half-bridge circuits and the control circuit 308 can be incorporated in the integrated circuit 330.

Two-phase operation reduces the current stress on the transistors of the half-bridge circuits with little to no increase in circuit area relative to single phase implementations. Because the two phases operate 180° out of phase, two phase operation can reduce the AC component of the current flowing in the input filter.

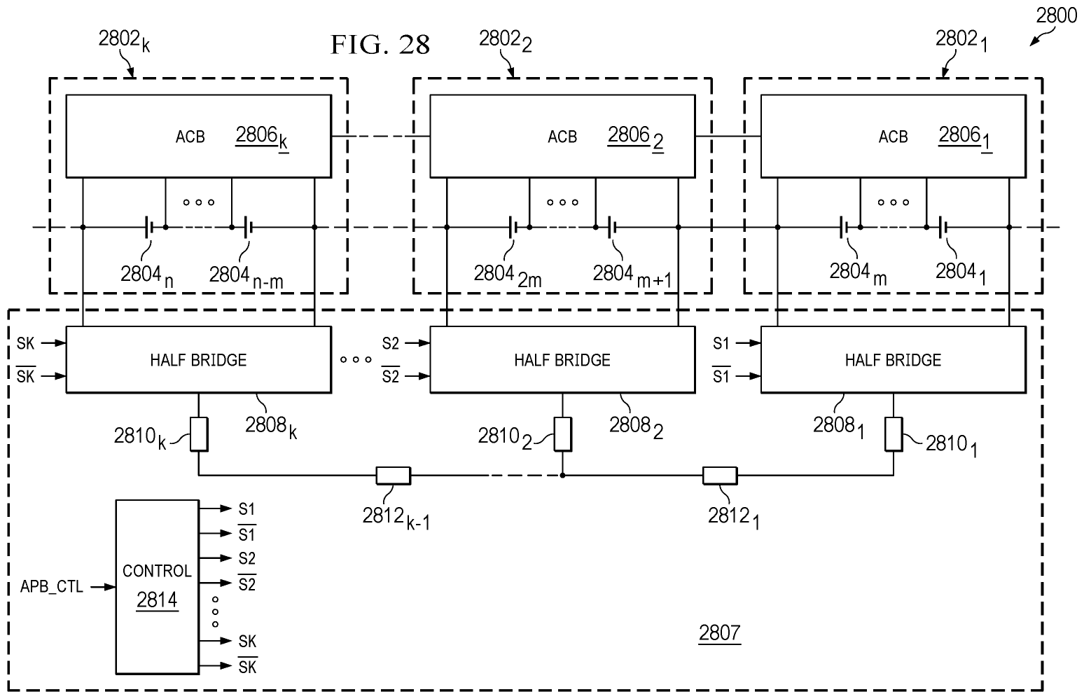

FIG. 28 is a block diagram of a battery assembly 2800 that includes balancing across battery modules. The battery assembly 2800 includes battery modules 2802₁ and 2802₂ through 2802ₖ. Each battery module includes battery cells and an active cell balancing circuit. The battery module 2802₁ includes m battery cells 2804₁ through 2804ₘ, each coupled to the active cell balancing circuit 2806₁. The active cell balancing circuit 2806₁ balances charge between the battery cells 2804₁ through 2804ₘ of the battery module 2802₁. The battery module 2802₂ is coupled in series with the battery module 2802₁, and includes m battery cells 2804ₘ₊₁ through 2804₂ₘ, each coupled to the active cell balancing circuit 2806₂. The active cell balancing circuit 2806₂ balances charge between the battery cells 2804ₘ₊₁ through 2804₂ₘ of the battery module 2802₂. The battery module 2802ₖ is coupled in series with the battery module 2802₂, and includes m battery cells 2804ₙ₋ₘ through 2804ₙ, each coupled to the active cell balancing circuit 2806ₖ. The active cell balancing circuit 2806ₖ balances charge between the battery cells 2804ₙ₋ₘ through 2804ₙ of the battery module 2802ₖ. The active cell balancing circuits 2806₁, 2806₂, and 2806ₖ can be examples of the active cell balancing circuit 206, the active cell balancing circuit 1706, the active cell balancing circuit 2206, the active cell balancing circuit 2506, or any other active cell balancing circuit described herein.

The battery assembly 2800 also includes a battery module balancing circuit 2807. The battery module balancing circuit 2807 balances charge between the battery modules 2802₁ through 2802ₖ. The battery module balancing circuit 2807 includes half-bridge circuits 2808₁, and 2808₂ through 2808ₖ, control circuit 2814, components 2810₁ and 2810₂ through 2810ₖ, and components 2812₁ through 2812ₖ₋₁. The half-bridge circuits 2808₁, and 2808₂ through 2808ₖ can be the same as the half-bridge circuit 302 with transistors rated for the battery module voltage. The control circuit 2814 is coupled to the half-bridge circuits 2808₁, and 2808₂ through 2808ₖ. The control circuit 2814 generates driver signals S1, S2, S̅2̅, SK, and S̅K̅ that control switching of the half-bridge circuits. \x \to(S1)

The components 2810₁ through 2810ₖ, and components 2812₁ through 2812ₖ₋₁ can be capacitors, inductors, conductors, or combinations (e.g., series combinations) thereof as described herein. In one example, the components 2810₁ through 2810ₖ are conductors, and the components 2812₁ through 2812ₖ₋₁ are examples of the LC circuit 306, as in the active cell balancing circuit 206. In such an example, the control circuit 2814 controls switching of the half-bridge circuits as described for the active cell balancing circuit 206.

In another example, the components 2810₁ through 2810ₖ are inductors, and the components 2812₁ through 2812ₖ₋₁ are capacitors, as in the active cell balancing circuit 1706. In such an example, the control circuit 2814 controls switching of the half-bridge circuits as described for the active cell balancing circuit 1706.

In another example, the components 2810₁ through 2810ₖ are capacitors, and the components 2812₁ through 2812ₖ₋₁ are inductors, as in the active cell balancing circuit 2206. In such an example, the control circuit 2814 controls switching of the half-bridge circuits as described for the active cell balancing circuit 2206.

In another example, the components 2810₁ through 2810ₖ are capacitors in series with inductors, and the components 2812₁ through 2812ₖ₋₁ are conductors, as in the active cell balancing circuit 2506. In such an example, the control circuit 2814 controls switching of the half-bridge circuits as described for the active cell balancing circuit 2506.

Various examples of the battery module balancing circuit 2807 can include switches in series with the components 2812₁ through 2812ₖ₋₁, and/or multiphase circuitry as described herein.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” means that the conduction channel of the FET is present and drain current may flow through the FET. References herein to a FET being “off” means that the conduction channel is not present and drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

1. An integrated circuit (IC) comprising:
a first transistor coupled between a first battery terminal and a capacitor terminal, the first transistor having a first transistor control terminal;
a second transistor coupled between the capacitor terminal and a second battery terminal, the second transistor having a second transistor control terminal;
a third transistor coupled between a third battery terminal and an inductor terminal, the third transistor having a third transistor control terminal, the third battery terminal coupled to the second battery terminal; and
a fourth transistor coupled between the inductor terminal and a fourth battery terminal, the fourth transistor having a fourth transistor control terminal; and
a control circuit having a control input and first, second, third, and fourth control outputs, in which the first control output is coupled to the first transistor control terminal, the second control output is coupled to the second transistor control terminal, the third control output is coupled to the third transistor control terminal, and the fourth control output is coupled to the fourth transistor control terminal.

2. The IC of claim 1, wherein the control circuit is configured to, responsive to a control signal:
within a first portion of a first switching cycle, provide a first driver signal having a first state at the first control output and a second driver signal having a second state at the second control output;
within a second portion of the first switching cycle, provide the first driver signal having a second state at the first control output and the second driver signal having a first state at the second control output;
within a first portion of a second switching cycle, provide a third driver signal having a first state at the third control output and a fourth driver signal having a second state at the fourth control output;
within a second portion of the second switching cycle, provide the third driver signal having a second state at the third control output and the fourth driver signal having a first state at the fourth control output; and
wherein:
the first transistor is enabled responsive to the first driver signal having the first state and is disabled responsive to the first driver signal having the second state;
the second transistor is enabled responsive to the second driver signal having the first state and is disabled responsive to the second driver signal having the second state;
the third transistor is enabled responsive to the third driver signal having the first state and is disabled responsive to the third driver signal having the second state; and
the fourth transistor is disabled responsive to the fourth driver signal having the second state and is enabled responsive to the fourth driver signal having the first state.

3. The IC of claim 2, wherein the control circuit is configured to, responsive to the control signal indicating a transfer of charge between the first and third battery terminals and between the second and fourth battery terminals, set an interval between a first transition of the first driver signal from the second state to the first state and a second transition of the third driver signal from the second state to the first state, in which the interval is based on an amount of current to be transferred.

4. The IC of claim 3, wherein the control circuit is configured to, responsive to the control signal indicating the transfer of the charge from the third battery terminal to the first battery terminal and from the fourth battery terminal to the second battery terminal, provide the second transition of the third driver signal at the interval before the first transition of the first driver signal.

5. The IC of claim 3, wherein the control circuit is configured to, responsive to the control signal indicating the transfer of the charge from the first battery terminal to the third battery terminal and from the second battery terminal to the fourth battery terminal, provide the second transition of the third driver signal at the interval after the first transition of the first driver signal.

6. The IC of claim 3, wherein the interval is based on at least one of: a voltage difference between the first and third battery terminals, or an inductance of an inductor coupled to the inductor terminal.

7. The IC of claim 3, wherein the control circuit is configured to:
provide the first and second driver signal having the second state within a first deadtime interval and a second deadtime interval of the first switching cycle, in which the first deadtime interval is before the first portion of the first switching cycle and the second deadtime interval is after the first portion of the first switching cycle; and
provide the third and fourth driver signal having the second state within a third deadtime interval and a fourth deadtime interval of the second switching cycle, in which the third deadtime interval is before the first portion of the second switching cycle and the fourth deadtime interval is after the first portion of the second switching cycle.

8. The IC of claim 2, wherein the inductor terminal is a first inductor terminal, the capacitor terminal is a first capacitor terminal, the fourth transistor is coupled between a second capacitor terminal and the fourth battery terminal, the second capacitor terminal coupled to the first inductor terminal, and the IC further comprises:
a fifth transistor coupled between a fifth battery terminal and a second inductor terminal, the fifth transistor having a fifth transistor control terminal, in which the fifth battery terminal is coupled to the fourth battery terminal; and
a sixth transistor coupled between the second inductor terminal and a sixth battery terminal, the sixth transistor having a sixth transistor control terminal;
wherein the control circuit has fifth and sixth control outputs, in which the fifth control output is coupled to the fifth transistor control terminal, the sixth control output is coupled to the sixth transistor control terminal, and the control circuit is configured to, responsive to the control signal:
within a first portion of a third switching cycle, provide a fifth driver signal having a first state at the fifth control output and a sixth driver signal having a second state at the sixth control output;
within a second portion of the third switching cycle, provide the fifth driver signal having a second state at the fifth control output and the sixth driver signal having a first state at the fifth control output;
wherein the fifth transistor is enabled responsive to the fifth driver signal having the first state and is disabled responsive to the fifth driver signal having the second state; and
wherein the sixth transistor is enabled responsive to the sixth driver signal having the first state and is disabled responsive to the sixth driver signal having the second state.

9. The IC of claim 8, wherein the control circuit is configured to, responsive to the control signal indicating a transfer of charge between the first battery terminal and the fifth battery terminal and between the second battery terminal and the sixth battery terminal:
provide a first transition of the first driver signal from the second state to the first state at a first interval before a second transition of the third driver signal from the second state to the first state; and
provide a third transition of the fifth driver signal from the second state to the first state at a second interval after the second transition of the third driver signal from the second state to the first state,
in which the first and second intervals are based on an amount of current to be transferred.

10. The IC of claim 9, wherein the first and second intervals are equal.

11. The IC of claim 8, wherein the control circuit is configured to, responsive to the control signal indicating a transfer of charge from the first battery terminal to the fifth battery terminal and from the second battery terminal to the sixth battery terminal:
provide a first transition of the first driver signal from the second state to the first state at an interval before a second transition of the fifth driver signal from the second state to the first state, in which the interval is based on an amount of current to be transferred; and
set the third and fourth driver signals to the second state within the interval.

12. The IC of claim 8, further comprising:
a seventh transistor coupled between a seventh battery terminal and a third inductor terminal, the seventh transistor having a seventh transistor control terminal, in which the seventh battery terminal is coupled to the sixth battery terminal; and
an eighth transistor coupled between the third inductor terminal and an eighth battery terminal, the eighth transistor having an eighth transistor control terminal;
wherein the control circuit has seventh and eighth control outputs, in which the seventh control output is coupled to the seventh transistor control terminal, the eighth control output is coupled to the eighth transistor control terminal, and the control circuit is configured to, responsive to the control signal:
within a first portion of a fourth switching cycle, provide a seventh driver signal having a first state at the seventh control output and an eighth driver signal having a second state at the eighth control output;
within a second portion of the fourth switching cycle, provide the seventh driver signal having a second state at the seventh control output and the eighth driver signal having a first state at the eighth control output;
wherein the seventh transistor is enabled responsive to the seventh driver signal having the first state and is disabled responsive to the seventh driver signal having the second state; and
wherein the eighth transistor is enabled responsive to the eighth driver signal having the first state and is disabled responsive to the eighth driver signal having the second state.

13. The IC of claim 12, wherein the control circuit is configured to
responsive to the control signal indicating a first transfer of charge between the first and third battery terminals and between the second and fourth battery terminals, and a second transfer of charge between the fifth and seventh battery terminals and between the sixth and eighth battery terminals:
set an interval between a first transition of the first driver signal from the second state to the first state and a second transition of the third driver signal from the second state to the first state, in which the interval is based on an amount of current to be transferred; and
set an interval between a first transition of the fifth driver signal from the second state to the first state and a second transition of the seventh driver signal from the second state to the first state, in which the interval is based on an amount of current to be transferred.

14. The IC of claim 2, further comprising:
a fifth transistor coupled between the capacitor terminal and the first and second transistors, the fifth transistor having a fifth transistor control terminal;
wherein the control circuit has a fifth control output coupled to the fifth transistor control terminal.

15. A method comprising:
connecting a capacitor and an inductor between a first battery terminal and a second battery terminal of a first battery cell to provide a first voltage across the capacitor, in which a capacitor terminal of the capacitor is connected to the first battery terminal, and an inductor terminal of the inductor is connected to the second battery terminal;
disconnecting the inductor terminal from the second battery terminal;
connecting the inductor terminal to the first battery terminal to provide the first voltage across the inductor;
disconnecting the capacitor terminal from the first battery terminal; and
connecting the capacitor terminal to a third battery terminal of a second battery cell to transfer charge from the capacitor to the second battery cell at a rate based on the first voltage and an inductance of the inductor.

16. The method of claim 15, further comprising:
determining a delay interval based on a target amount of current to be from the first battery cell to the second battery cell; and
delaying the connecting of the capacitor terminal to the third battery terminal with respect to the connecting of the inductor terminal to the first battery terminal by the delay interval.

17. A system comprising:
an integrated circuit including:
a first transistor coupled between a first battery terminal and a capacitor terminal, the first transistor having a first transistor control terminal;
a second transistor coupled between the capacitor terminal and a second battery terminal, the second transistor having a second transistor control terminal;
a third transistor coupled between a third battery terminal and an inductor terminal, the third transistor having a third transistor control terminal; and
a fourth transistor coupled between the inductor terminal and a fourth battery terminal, the fourth transistor having a fourth transistor control terminal; and
a control circuit having a control input and first, second, third, and fourth control outputs, in which the first control output is coupled to the first transistor control terminal, the second control output is coupled to the second transistor control terminal, the third control output is coupled to the third transistor control terminal, and the fourth control output is coupled to the fourth transistor control terminal; and
a capacitor and an inductor coupled between the capacitor terminal and the inductor terminal.

18. The system of claim 17, further comprising a switch coupled between the capacitor terminal and the capacitor, or between the inductor terminal and the inductor.

19. The system of claim 17, wherein the control circuit is configured to, responsive to a control signal:
within a first portion of a first switching cycle, provide a first driver signal having a first state at the first control output and a second driver signal having a second state at the second control output;
within a second portion of the first switching cycle, provide the first driver signal having a second state at the first control output and the second driver signal having a first state at the second control output;
within a first portion of a second switching cycle, provide a third driver signal having a first state at the third control output and a fourth driver signal having a second state at the fourth control output;
within a second portion of the second switching cycle, provide the third driver signal having a second state at the third control output and the fourth driver signal having a first state at the fourth control output; and
wherein:
the first transistor is enabled responsive to the first driver signal having the first state and is disabled responsive to the first driver signal having the second state;
the second transistor is enabled responsive to the second driver signal having the first state and is disabled responsive to the second driver signal having the second state;
the third transistor is enabled responsive to the third driver signal having the first state and is disabled responsive to the third driver signal having the second state; and
the fourth transistor is disabled responsive to the fourth driver signal having the second state and is enabled responsive to the fourth driver signal having the first state.

20. The system of claim 19, wherein:
the inductor terminal is a first inductor terminal, the capacitor terminal is a first capacitor terminal, the fourth transistor is coupled between a second capacitor terminal and the fourth battery terminal, the second capacitor terminal coupled to the first inductor terminal;
the integrated circuit further comprises:
a fifth transistor coupled between a fifth battery terminal and a second inductor terminal, the fifth transistor having a fifth transistor control terminal, the second inductor terminal coupled to a third capacitor terminal; and
a sixth transistor coupled between the third capacitor terminal and a sixth battery terminal, the sixth transistor having a sixth transistor control terminal; and
a seventh transistor coupled between a seventh battery terminal and a third inductor terminal, the seventh transistor having a seventh transistor control terminal, in which the seventh battery terminal is coupled to the sixth battery terminal; and
an eighth transistor coupled between the third inductor terminal and an eighth battery terminal, the eighth transistor having an eighth transistor control terminal;
the control circuit has fifth, sixth, seventh, and eighth control outputs, in which the fifth control output is coupled to the fifth transistor control terminal, the sixth control output is coupled to the sixth transistor control terminal, the seventh control output is coupled to the seventh transistor control terminal, and the eighth control output is coupled to the eighth transistor control terminal.

21. The system of claim 20, wherein the inductor is a first inductor, the capacitor is a first capacitor, and the system further comprises a second capacitor and a second inductor coupled between the second capacitor terminal and the second inductor terminal, and a third capacitor and a third inductor coupled between the third capacitor terminal and the third inductor terminal; and
wherein the second capacitor is coupled to the first inductor, and the third capacitor is coupled to the second inductor.

22. The system of claim 20, wherein the control circuit is configured to, responsive to the control signal:
within a first portion of a third switching cycle, provide a fifth driver signal having a first state at the fifth control output and a sixth driver signal having a second state at the sixth control output;
within a second portion of the third switching cycle, provide the fifth driver signal having a second state at the fifth control output and the sixth driver signal having a first state at the fifth control output;
wherein the fifth transistor is enabled responsive to the fifth driver signal having the first state and is disabled responsive to the fifth driver signal having the second state; and
wherein the sixth transistor is enabled responsive to the sixth driver signal having the first state and is disabled responsive to the sixth driver signal having the second state.

23. The system of claim 22, wherein the control circuit is configured to, responsive to the control signal indicating a transfer of charge from the first battery terminal to the fifth battery terminal and from the second battery terminal to the sixth battery terminal:
provide a first transition of the first driver signal from the second state to the first state at an interval before a second transition of the fifth driver signal from the second state to the first state; and
provide a third transition of the fifth driver signal from the second state to the first state at a second interval after the second transition of the third driver signal from the second state to the first state.

24. A system comprising:
a first module including one or more pairs of first half bridge circuits coupled between a first terminal and a second terminal, each of the one or more pairs of first half bridge circuits having a respective first current terminal, and the first module including a first inductor and a first capacitor coupled between the first current terminals of each pair of the first half bridge circuits;
a second module including one or more pairs of second half bridge circuits coupled between a third terminal and a fourth terminal, the third terminal coupled to the second terminal, each of the one or more pairs of second half bridge circuits having a respective current terminal, and the second module including a second inductor and a second capacitor coupled between the second current terminals of each pair of the second half bridge circuits;
a third half bridge circuit coupled between the first terminal and the second terminal, the third half bridge circuit having a third current terminal and a first control terminal;
a fourth half bridge circuit coupled between the third terminal and the fourth terminal, the fourth half bridge circuit having a fourth current terminal and a second control terminal;
an inductor and capacitor (LC) network coupled between the third and fourth current terminals;
a control circuit having a control input and first and second control outputs, in which the first control output is coupled to the first control terminal, and the second control output is coupled to the second control terminal.

25. The system of claim 24, further comprising:
a first switch coupled between the third current terminal and the capacitor and inductor network; and
a second switch coupled between the fourth current terminal and the capacitor and inductor network.

26. The system of claim 24, wherein the first module is part of a first battery module, the second module is part of a second battery module, and the system further comprises first batteries coupled between the first terminal and the second terminal, and second batteries coupled between the third terminal and the fourth terminal.
